(19) United States
(12) Patent Application Publication
(10) Pub. No.: US 2008/0140655 A1
(43) Pub. Date: Jun. 12, 2008

(54) Systems and Methods for Storing, Maintaining and Providing Access to Information

(76) Inventors: Holger H. Hoos, Vancouver (CA); Juergen Kilian, Fuerth (DE); Ronald A. Rensink, Vancouver (CA)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/793,245

(22) PCT Filed: Dec. 15, 2005
(86) PCT No.: PCT/CA05/01901

§ 371 Date: Jun. 14, 2007

Related U.S. Application Data
(60) Provisional application No. 60/636,208, filed on Dec. 15, 2004.

(51) Int. Cl. G06F 17/30; G06F 12/00

(52) U.S. Cl. 707/6; 707/200; 707/E17.009; 707/E17.014

(57) ABSTRACT

Systems and methods are provided for organizing a plurality of information objects in a dynamic network. The method involves a network comprising: a plurality of nodes wherein each node represents a corresponding one of the information objects and each node has an associated node strength; and a plurality of links wherein each link represents a connection between a corresponding pair of nodes. The method involves: selecting a first node from among the plurality of nodes to be the currently selected node; and in response to selection of the first node as the currently selected node, increasing the node strength of the first node.

### REFERENCE TO RELATED APPLICATIONS

This application claims priority from U.S. patent application No. 60/636,208 filed 15 Dec. 2004 which is hereby incorporated by reference herein. This application is related to the co-pending application entitled PROBABILISTIC AUDIO NETWORKS being filed together herewith.

### TECHNICAL FIELD

The invention relates to systems and methods for storing, maintaining and providing access to information.

### BACKGROUND

The way in which information is stored and organized has historically been central to the way that individuals, organizations, and whole societies work and think. Written language, the printing press, vertical filing cabinets, personal computers, and the internet have all had an enormous impact on the ability to store and retrieve increasingly large amounts of information efficiently. Nevertheless, most if not all widely used methods and apparatus for electronically storing and organizing information (e.g. computers, processor-based systems and the like) are based on principles and user interfaces derived from earlier and more restrictive techniques, such as hierarchical folders, desktops, etc.

Most systems with accessible memory make use of an inherently hierarchical structure for maintaining, organizing and providing access to information. Examples of hierarchical structures include conventional file systems used by computer operating systems (including Windows™, Mac OS™ and Unix™), by e-mail systems, by electronic address books, and in the bookmark collections maintained by web-browsers.

In many cases, a strictly hierarchical structure is overly restrictive. Consequently, some modern file systems extend the hierarchical structure by supporting cross-links between different parts of an underlying hierarchical structure. For example, “shortcuts” in the Windows™ operating system may be placed on the “desktop” folder to access files in other folders. However, extensively cross-linked file systems can be difficult to maintain and inefficient (in terms of memory usage). As a result, many users utilize cross-linking features only sporadically, if at all.

Users may become frustrated, because they cannot efficiently access information which they know exists within their system in a simple and natural way and because maintaining and/or organizing information is an increasingly complex and time-consuming task. While search engines and tools that scan whole file systems or e-mail archives for a given piece of information offer some remedy, these tools can be difficult to use and do not have the capacity to concentrate the search based on recently accessed or frequently accessed portions of the file system.

Given the increasing data storage capacities of modern computers, computer networks and other systems with access to memory, together with the increasing volume of electronic information, there is a need for efficient systems to provide storage, organization and/or access to information.

### BRIEF DESCRIPTION OF DRAWINGS

In drawings which show non-limiting embodiments of the invention:

FIG. 1 schematically depicts an example of an inventive system for storing, maintaining and providing access to information and for carrying out the inventive methods for storing, maintaining and providing access to information in accordance with a particular embodiment of the invention;

FIG. 2 depicts the data storage of the FIG. 1 system and a schematic illustration of an example network which may be used to perform the methods of the invention;

FIGS. 3A, 3B and 3C respectively schematically illustrate data structures that may be used by the FIG. 1 system to implement the content nodes, property nodes and links of the FIG. 2 network;

FIG. 4 is a schematic illustration of the FIG. 2 network wherein a new link has been created;

FIG. 5A is schematic diagram showing a process for dynamically updating the node strength of an example node according to a particular embodiment of the invention;

FIG. 5B is a schematic diagram showing a process for dynamically updating the link strength of an example link according to a particular embodiment of the invention;

FIGS. 6A-6D schematically depict the state of an example network at various successive discrete intervals to illustrate the propagation of activation through the example network;

FIG. 7A schematically depicts a number of lists which may be used to organize the nodes and links of the FIG. 2 network;

FIG. 7B is a schematic representation of the FIG. 7A node list;

FIG. 7C is a schematic representation of the FIG. 7A link list;

FIG. 7D is a schematic representation of the FIG. 7A keyword list;

FIG. 7E is a schematic representation of the FIG. 7A high-node-strength list;

FIG. 7F is a schematic representation of the FIG. 7A high-link-strength list;

FIG. 7G is a schematic representation of the FIG. 7A connected-node list;

FIG. 8A is a schematic representation of a portion of the user interface of the FIG. 1 system incorporating information from a high-node-strength list;

FIG. 8B is a schematic representation of the FIG. 8A high-node-strength list after selection of a new node as the currently-selected node;

FIG. 9A is a schematic illustration of a media content data structure according to a particular embodiment of the invention;

FIG. 9B is a schematic illustration of an artist data structure according to a particular embodiment of the invention;

FIG. 9C is a schematic illustration of a playlist data structure according to a particular embodiment of the invention;

FIG. 10 is a schematic illustration of a portion of a user interface display incorporating information from a high-node-strength list for the case where the system is a media playback system;

FIG. 11 is a schematic state diagram of a system for playing back digital audio information in accordance with a particular embodiment of the invention; and

FIG. 12 is a schematic depiction of a system for storing, maintaining and providing access to information and for carrying out the inventive methods for storing, maintaining and providing access to information in accordance with a particular embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Aspects of the invention provides methods and systems for storing, maintaining and providing access to information and for carrying out the inventive methods for storing, maintaining and providing access to information. Particular embodiments, of the invention provide systems and methods for organizing a plurality of accessible information items. Such systems and methods establishing a plurality of nodes and a plurality of links. Each node corresponds to one of the information items and each node has an associated node strength. Each link represents a connection between a corresponding pair of nodes. A user may select a first node from among the plurality of nodes to be a currently-selected node. In response to selection of the first node as the currently-selected node, the node strength of the first node is increased.

In some embodiments, the systems and methods of the invention maintain a high-node-strength list of some of the nodes from among the plurality of nodes. The high-node-strength list is ordered by node strength. When the node strength of the first node is increased, it may move toward the top of the high-node-strength list. Indicia representing the information items corresponding to the nodes on the high-node-strength list may be displayed on a user interface such that a user can identify the information items from the display indicia. A user can then access desired information item(s) corresponding to particular node(s) on the high-node-strength list by selecting the displayed indicia corresponding to the desired information item(s) and providing an indication that access is requested.

in response to selection of the first node as the currently-selected node, activation may be propagated from the first node to one or more second nodes over one or more links connecting the first node to the one or more second nodes. In response to receiving the activation at the one or more second nodes, the node strengths of the one or more second nodes may also be increased. In response to increasing the node strength of the one or more second nodes, the one or more second nodes may be moved toward the top of the high-node-strength list. The links may also be provided with corresponding link strengths. The amount of activation propagated from the first node to a particular one of second nodes and the increase in node strength of each of the particular one of second nodes may depend on the link strength of the links connecting the first node to the second node. The link strengths may also be increased in response to propagation of activation over the link.

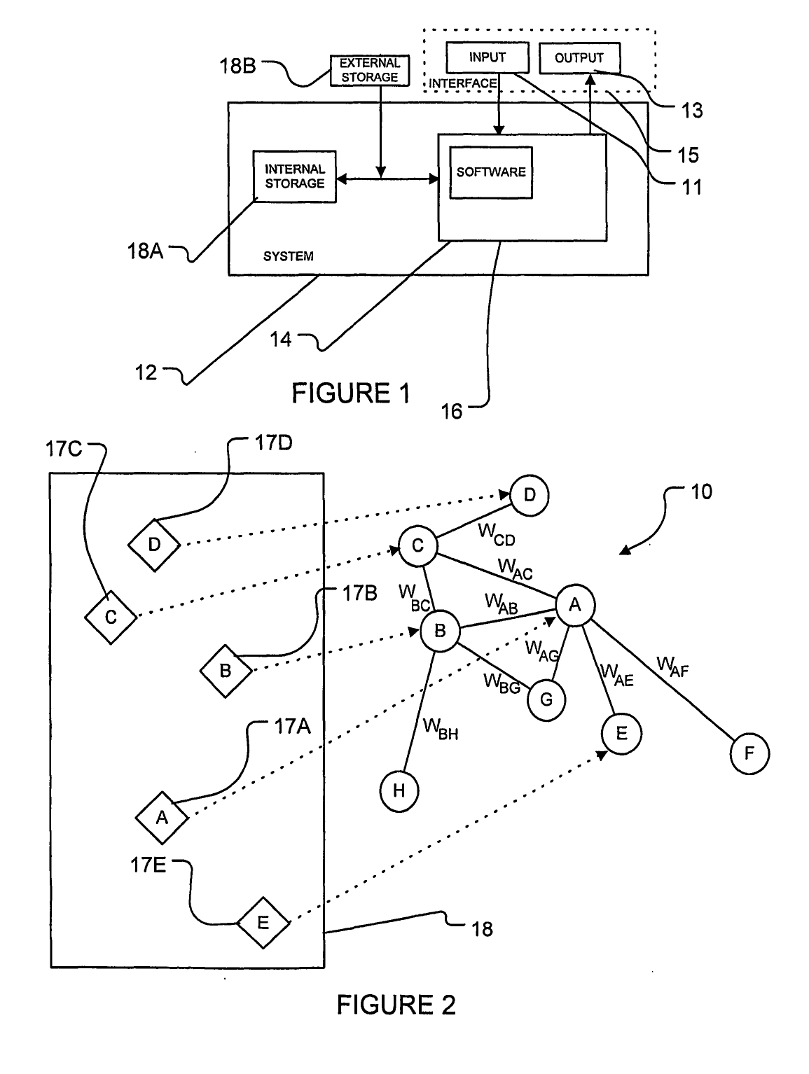

FIG. 1 depicts an example system 12 for storing, maintaining and providing access to information and for carrying out inventive methods for storing, maintaining and providing access to information. System 12 may comprise a computer, an embedded system, part of a communication network, a stand-alone device or any other system or device which comprises a processor 14 capable of executing program instructions 16 and which comprises, or is otherwise capable of providing access to, internal data storage 18A and/or external data storage 18B (collectively, data storage 18). Data storage 18 may comprise any suitable storage medium, such as an optical disk, magnetic disk, solid state memory, flash memory, a combination thereof or the like. A user may interact with system 12 via input device 11 and output device 13. Input device 11 may comprise one or more of any suitable input device, such as a mouse, a keyboard, a series of buttons, a rolling input or the like, for example. Similarly, output device 13 may comprise one or more of any suitable output device, such as a flat screen display, an audio output device, a CRT monitor or the like for example. System 12 and/or software 16 may cause input device 11 and output device 13 to work together to provide a user interface 15 (e.g. a graphical and/or text-based user interface). In general, the invention disclosed herein is not limited to any particular selection of data storage 18, input device 11 or output device 13.

System 12 may be a stand-alone unit or may itself be a part of an external communication network (not shown), such as a local area communication network (LAN) or the internet, for example. External data storage 18B may be directly accessible by system 12 or may be accessible through such an external communication network. Software 16 may be executed by data processor 14 and may control how data processor 14 (and any other components of system 12) access data storage 18.

Data storage 18 is schematically depicted in FIG. 2. Data storage 18 may store information items 17A-17E (collectively and individually, information items 17). For simplicity, in the illustrated example of FIG. 2, data storage 18 is shown as storing only five information items 17A-17E. In general, the number of information items 17 stored by data storage 18 may be much larger (e.g. 10⁵ or more information items 17) and is only limited by the capacity of data storage 18. Information items 17 may generally comprise any type of information. In one particular example embodiment, information items 17 comprise media content, which may be played back on a digital media player, for example. In another example embodiment, information items 17 comprise electronic documents, such as word processor files, multimedia files and/or emails, for example.

Within the context of data storage 18, information items 17 may be disorganized or organized in an inconvenient manner. By way of non-limiting example, information items 17 may be stored in different directories or “folders”, information items 17 may be stored on different data storage units (e.g. an optical disc drive and a magnetic hard drive), and information items 17 may be stored in local data storage 18A and remote data storage 18B. In accordance with a particular embodiment of the invention shown in FIG. 2, system 12 and/or software 16 creates a network 10 which represents information items 17 and provides techniques for organizing and accessing information items 17.

FIG. 2 depicts an example network 10 which represents information items 17. In the illustrated example, network 10 comprises a plurality of nodes (represented by circles labeled A-H) and a plurality of links connecting pairs of nodes (represented by lines labeled w_{xy}, where x and y represent the labels of the nodes connected by the link w_{xy}). Nodes A-H and links w_{AB}, w_{BC} . . . may be implemented by system 12 and/or software 16 as data structures or parts of data structures.

Network 10 may be tangibly embodied as a plurality of related data entities which may be maintained and dynamically updated by system 12. Network 10 may be implemented in software or hardware or a combination of software and hardware. In specific embodiments, the data entities of network 10 may take the form of data structures. As described below, network 10 assists system 12 (and users of system 12) to manage information items 17 contained in data storage 18. Users interact with network 10, and network 10 interacts with users, via user interface 15. For ease of explanation, network 10 may be conceptualized as a plurality of nodes A-H and links w_{AB}, w_{BC} . . . discussed herein.

As explained in more detail below, nodes A-H may be assigned node strengths which may be used by system 12 and/or software 16 to organize and/or display indicia of information items 17 according to the node strengths of their corresponding nodes. For example, system 12 may display a list containing indicia of information items 17 corresponding to nodes A-H (or a subset of nodes A-H). This list may be sorted by node strength to allow a user to directly select node(s) or access information item(s) 17 corresponding to node(s) having relatively high node strength(s). Lists of nodes may be displayed, selected or have their corresponding information items 17 accessed based on their node strengths or based on other criteria as explained in more detail below.

The node strength of nodes A-H may be dynamically updated. If a user selects a node (e.g. node B) and/or accesses an information item (e.g. information item 17B) corresponding to a particular node, then system 12 and/or software 16 may increase the node strength of the particular node selected/accessed by the user and may propagate activation to related nodes (e.g. nodes A, C, G and H) via links (e.g. w_{AB}, w_{BC}, w_{BH}, w_{BG}) which connect the selected/accessed node to related nodes. Such propagated activation may cause system 12 and/or software 16 to increase the node strengths of the nodes which are related to the node selected/accessed by the user (e.g. increasing the node strengths of nodes A, C, G and H). The organization and/or display of various indicia of information items 17 according to the node strength of their corresponding nodes may also be dynamically updated to reflect the changes in node strengths of the selected/accessed node (e.g. node B) and the related nodes (e.g. nodes A, C, G and H) connected to node B via links. The increase in link strength of these nodes may make them more prominent to a user. For example, in the case where system 12 displays a list containing indicia identifying specific information items 17 corresponding to nodes A-H (or a subset of nodes A-H), this list may be resorted to reflect the increase in node strengths of node B and related nodes A, C, G and H.

In the embodiment of FIG. 2, nodes A-E respectively represent information items 17A-17E and are referred to herein as “content nodes”. Content nodes A-E of network 10 each have a one-to-one relationship with their corresponding information items 17A-17E. In some embodiments, the data structures corresponding to content nodes A-E contain their corresponding information items 17A-17E. Preferably, however, the data structures corresponding to content nodes A-E contain information recognizable to system 12 and/or software 16 about how to access their corresponding information items 17A-17E. By way of non-limiting example, such information may include: a universal remote locator (URL); an internet protocol address; a directory path and filename; a memory address or the like. Information about how to access a particular information item (e.g. information item 17A) is referred to herein as a “pointer” to information item 17A.

The concept of pointers is well understood by software engineers. Pointers may point to information items 17 that reside in internal data storage 18A, to information items 17 that reside in external data storage 18B and/or to information items 17 that reside in part in internal data storage 18A and in part in external data storage 18B. In the case where pointers point to information that resides in external data storage 18B, such external data storage may be accessed via the internet or some other communication network.

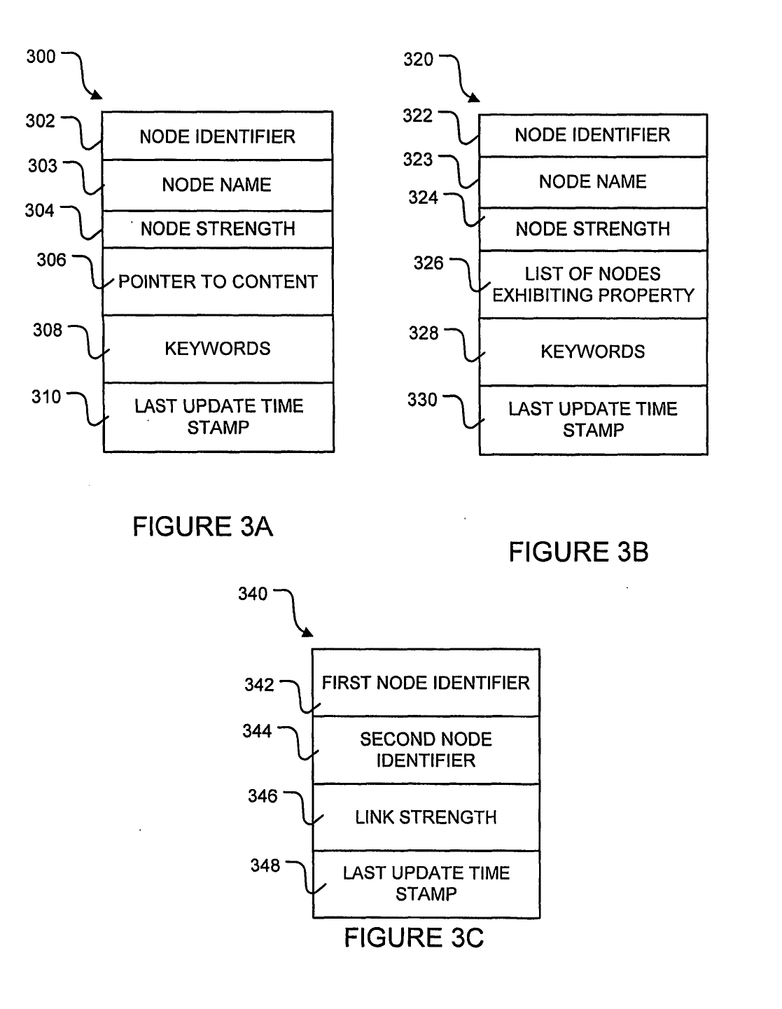

FIG. 3A schematically depicts a data structure 300 which is used to implement content nodes A-E of network 10 in a particular embodiment of the invention. Content node data structure 300 comprises:
a node identifier 302 which uniquely identifies the node and its corresponding information item 17;
a node name 303 which preferably provides a user with a means of identifying its corresponding information item 17;
a node strength 304 (explained in more detail below);
a pointer 306 to its corresponding information item 17;
a field 308 containing keywords that relate to its corresponding information item 17 and/or to properties/characteristics of its corresponding information item 17 (e.g. keywords in the name of information item 17); and
a last update time stamp which represents the last time that the node strength 304 was updated (explained in more detail below).

In the FIG. 2 example network 10, nodes F-G do not directly represent information items 17, but rather nodes F-G represent information about information items 17 (e.g. properties or characteristics of information items 17) and are referred to herein as “property nodes”. Property nodes F-G may be created from metadata associated with information items 17 or by analyzing information items 17 to extract one or more properties of information items 17. Property nodes F-G may also be created by user input. Property nodes F-G may represent information about one or more other nodes of network 10 and in turn one or more information items 17. Property nodes F-G are optional.

FIG. 3B schematically depicts a data structure 320 which is used to implement property nodes F-H of network 10 in a particular embodiment of the invention. Property node data structure 320 comprises:
a node identifier 322 which uniquely identifies the node;
a node name 323 which preferably provides a user with a means of identifying the property represented by the node;
a node strength 324 (explained in more detail below);
a list 326 of pointers (node identifiers) to one or more nodes which represent information items 17 which exhibit a particular property;
a field 328 containing keywords that relate to the particular property and/or to information items 17 that exhibit the particular property; and
a last update time stamp which represents the last time that the node strength 324 was updated (explained in more detail below).

In other embodiments, data structures 300 corresponding to content nodes A-E and data structures 320 corresponding to property nodes F-H may contain additional fields. Such additional fields may relate to other properties of information items 17, for example.

Links w_{AB}, w_{BC} . . . of network 10 represent relevance relationships between the respective nodes connected by the links. By way of non-limiting example, network 10 may comprise a link between two content nodes that are similar to one another and/or link(s) between a property node one or more content nodes which exhibit that property. Links w_{AB}, w_{BC} . . . of network 10 may also be implemented by system 12 and/or software 16 as data structures. FIG. 3C schematically depicts a data structure 340 which may be used to implement a link of network 10 according to a particular embodiment of the invention. Link data structure 340 comprises:
a first node identifier 342 which uniquely identifies a first node to which the link is connected;
a second node identifier 344 which uniquely identifies a second node to which the link is connected;
a link strength 346 (explained in more detail below); and
a last update time stamp that indicates the last time that the link strength 346 was updated (explained in more detail below).

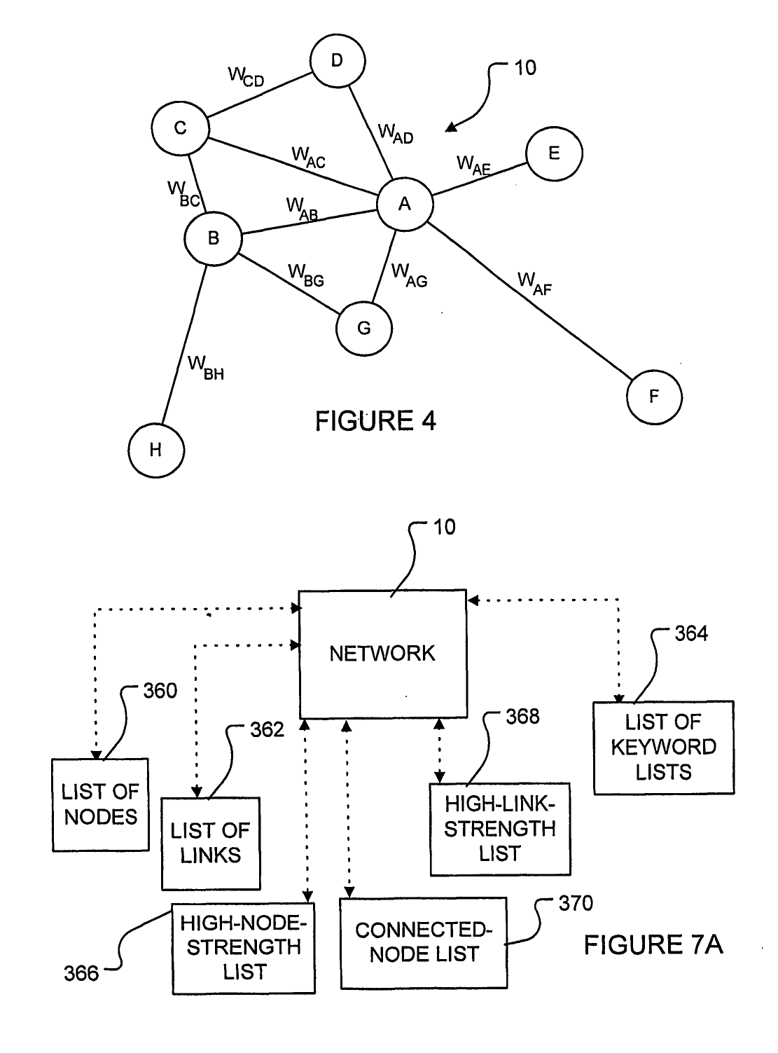

Links w_{AB}, w_{BC} . . . of network 10 may be automatically created by system 12 and/or software 16. Links w_{AB}, w_{BC} . . . of network 10 may also be created by users. The creation of links w_{AB}, w_{AC}, . . . may be based on the similarity of properties of the information items 17 represented by the corresponding content nodes A-E, based on a node exhibiting the property of a property node F-H and/or based on information relating to usage of nodes A-H. For example, FIG. 4 shows network 10 of FIG. 1A, except that a new link w_{AD} has been created to connect nodes A and D.

The creation of links w_{AB}, w_{AC}, . . . based on the similarity of properties of the information items 17 represented by the corresponding content nodes A-E may be performed by analyzing and comparing the information items 17 represented by content nodes A-E or by analyzing and comparing properties of the information represented by content nodes A-E (e.g. metadata associated with information items 17). The creation of links w_{AB}, w_{AC}, . . . based on a node exhibiting the property of a property node F-H may be also be performed by analyzing the information items 17 represented by content nodes A-E or by analyzing properties of the information items 17 represented by content nodes A-E.

Links between nodes may also be created on the basis of usage. System 12 and/or software 16 may observe a relationship between the usage of two nodes A and D and may automatically create link w_{AD} (FIG. 4) on the basis of this usage relationship. For example, system 12 and/or software 16 may monitor the access to and/or selection of nodes A-H of network 10. If nodes A and D are accessed and/or selected one after another or within a certain threshold interval of one another, then a link w_{AD} may be added to network 10. In some embodiments, the time between access and/or selection of a first node and a next node is monitored using the last update time stamp field 310 of the content data structure 300 or the last update time stamp filed 330 of the property data structure 320. The threshold interval need not be a temporal interval and may relate to a number of discrete intervals t. Discrete intervals t are explained in more detail below.

In accordance with particular embodiments of the invention, a node strength is assigned to each of the nodes A-H in network 10 (see node strength fields 304 and 324 of data structures 300, 320). The node strengths of various nodes A-H of network 10 may conveniently be represented by numerical values and may be dynamically updated (as explained in more detail below). In some embodiments, the node strength of a particular content node depends on an amount that the information item 17 corresponding to the content node has been accessed/selected and/or to a recency of access to/selection of the information item 17 represented by the content node.

Accordingly, a content node with a relatively high node strength may be considered by system 12 and/or software 16 to be more heavily or recently accessed/selected, while a node with a relatively low node strength may be considered by system 12 and/or software 16 to be less heavily accessed/selected or less recently accessed/selected.

A link strength may also optionally be assigned to each link w_{AB}, w_{AC} . . . in network 10 (see the link strength field 346 of data structure 340). Link strengths may be conveniently represented as numerical values and may be dynamically updated (as explained in more detail below). In some embodiments, the strengths of particular links w_{AB}, w_{AC}, . . . in network 10 which connect content nodes depend on the degree of similarity between their corresponding content nodes. Accordingly, a link with a relatively high strength may be considered by system 12 and/or software 16 to connect content nodes that are relatively similar, while a link with a relatively low strength may be considered by system 12 and/or software 16 to connect content nodes that are relatively dissimilar. In other embodiments, the link strength of a particular link connecting a pair of nodes depends on an abstract degree of relationship between the nodes. In some embodiments, the link strength of a particular link connecting content nodes depends additionally or alternatively on an amount that the information items 17 represented by its corresponding content nodes have been accessed/selected and/or to a recency of access to/selection of the information items 17 represented by its corresponding nodes. Accordingly, a link with a relatively high link strength may be considered by system 12 and/or software 16 to link nodes which have been more heavily or recently accessed/selected, while a link with a relatively low link strength may be considered by system 12 and/or software 16 to link nodes which have been less heavily accessed/selected or less recently accessed/selected.

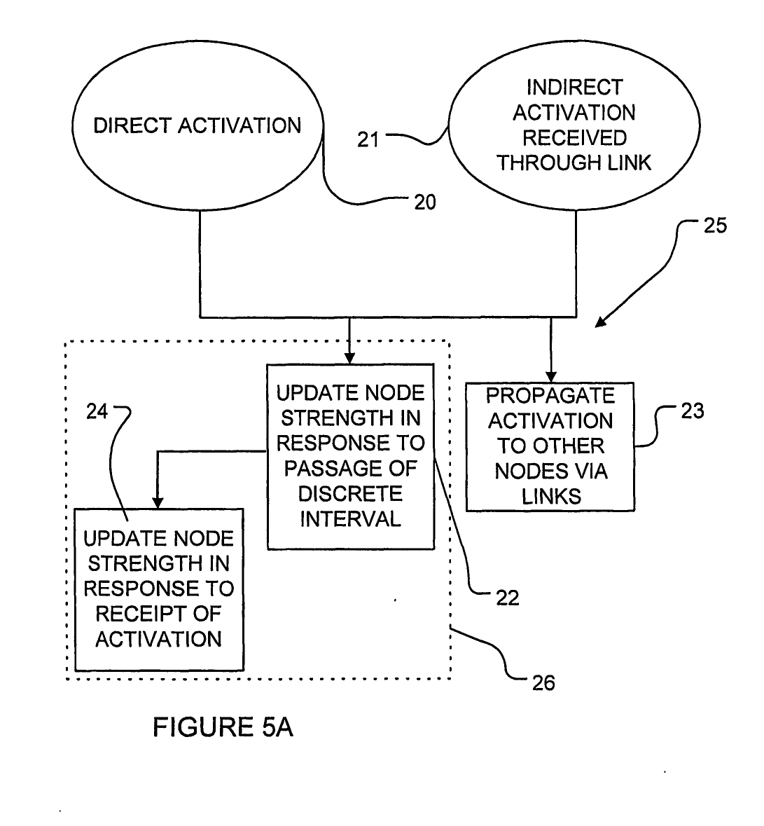

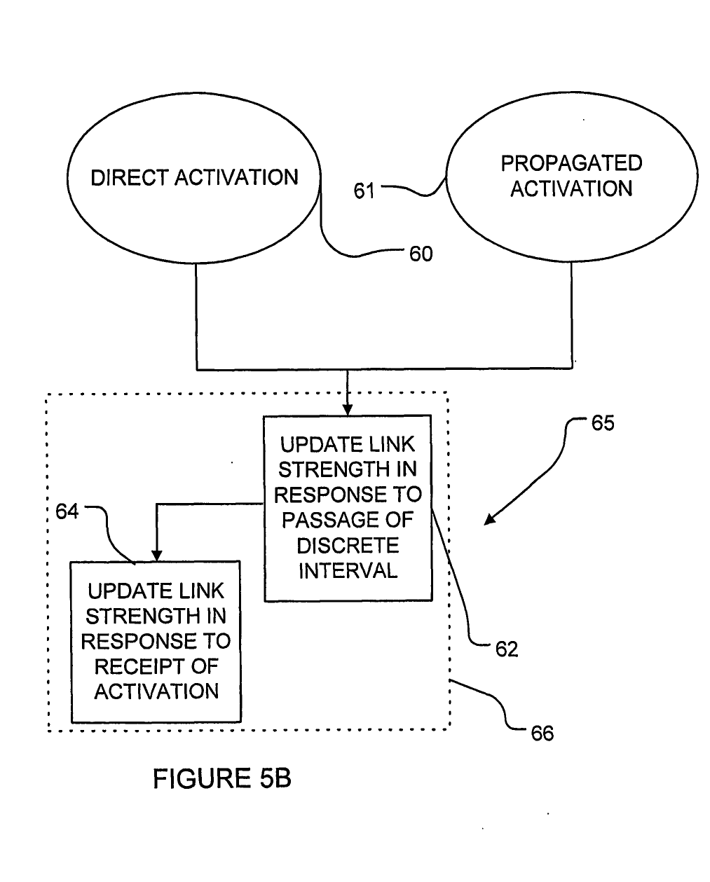

FIG. 5A is a schematic block diagram representation of a method 25 for dynamically updating the node strength a particular node n in network 10 in accordance with a particular embodiment of the invention. Node n is not explicitly shown in FIG. 5A but may generally be any node in network 10. In some embodiments, method 25 occurs once for each node A-H in network 10 at every discrete interval t. In other embodiments, method 25 (or various aspects of method 25) occur(s) more than once in a given discrete interval t. In still other embodiments, method 25 does not occur unless a node receives activation (explained in more detail below). Discrete intervals t may be temporal intervals or they may represent the intervals between repetitive events. Intervals between repetitive events need not be temporally constant.

In accordance with method 25, node n may receive direct activation 20 in discrete interval t. Direct activation 20 may come from an external source, such as a user, system 12 or software 16 accessing the information item 17 represented by node n or selecting node n to be a “currently-selected node”. Selection of node n to be the currently-selected node does not necessarily require access to an information item 17 represented by node n. In this manner, a user may provide direct activation 20 to node n by interacting with user interface 15 in such a manner that node n becomes the currently-selected node. In addition, a user can cause a property node to become the currently-selected node. System 12, software 16 and/or a user may additionally or alternative make a decision to provide node n with direct activation via other means.

As shown in FIG. 5A, node n may also receive indirect activation 21 in the discrete interval t. Indirect activation 21 of node n refers to activation which originates as direct activation at a neighboring node m and which propagates from neighboring node m through one or more links to node n. Neighboring node m need not necessarily be an immediate neighbor of node n (i.e. connected to node n via a single link). There may be several nodes and links between nodes n and m. The direct activation received at neighboring node m may originate from an external source (e.g. a user, system 12 or software 16 accessing the information item 17 represented by node m and/or selecting node m to be a currently-selected node) and/or because system 12, software 16 or a user makes a decision to provide direct activation to node m via some other means.

As shown at block 23 of FIG. 5A, node n may propagate activation to other nodes via its connected links. The neighboring nodes (i.e. nodes connected to node n via links) may then receive activation from node n. Such activation will represent indirect activation for the neighboring nodes (i.e. similar to indirect activation 21 received by node n). For a particular neighboring node n′, the amount of activation propagated in block 23 may depend on the amount of activation (direct activation 20 and indirect activation 21) received by node n, the source of the indirect activation 21 (if any) and/or the link strength of the link w_{nn′} connecting node n to neighboring node n′. In some embodiments, the amount of activation propagated by node n to a neighboring node n′ during a discrete interval t is positively correlated with the amount of direct and/or indirect activation received at node n and/or with the link strength of the link w_{nn′} connecting node n to neighboring node n′. In general, the sum of the activation propagated from node n to all of its neighboring nodes is less than the amount of activation received at node n.

In some embodiments, the amount of activation propagated by node n to a directly neighboring node n′ over link w_{nn′} in block 23 may be determined as follows. If node n receives an amount of direct activation p(n), then the amount of indirect activation λₚᵣₒₚ(n, n′) propagated from node n to a neighboring node n′ may be given by:

$${λ}_{prop} ( n , {n}^{′} ) := \frac{μ ( n ) \cdot Ω \cdot assoc ( n , {n}^{′} )}{{\sum }_{i} assoc ( n , i )} ,$$

where Ω:(0,1) is a propagation decay factor; assoc(n,n′) is the link strength of the link w_{nn′}; and the summation in the denominator is the sum of the link strengths over all of the links connected to node n. If node n receives an amount of indirect activation λᵣₓ(n, n*) from a neighboring node n* over link w_{nn*}, then the amount of indirect activation λₚᵣₒₚ(n, n′) propagated from node n to a neighboring node n′ may be given by:

$${λ}_{prop} ( n , {n}^{′} ) = \{ \begin{matrix}\frac{{λ}_{rx} ( n , {n}^{*} ) \cdot Ω \cdot assoc ( n , {n}^{′} )}{{\sum }_{i} [ assoc ( n , i ) ] - assoc ( n , {n}^{*} )} & if {n}^{′} \neq {n}^{*} \\ 0 & if {n}^{′} = {n}^{*}\end{matrix}$$

These equations show how the sum of the activation propagated from node n to all of its neighboring nodes will be less than the total activation received by node n by an amount determined by a propagation decay factor Ω. The equation for propagation of indirect activation received by node n also adds a constraint that indirect activation is not propagated back towards the node that it came from. For example, if node n receives an amount of indirect activation λᵣₓ(n, n*) from a neighboring node n* over link w_{nn*}, then the amount of activation propagated back to node n* is zero.

Block 23 may also involve a thresholding process which may be used to cutoff the propagation of activation. In some embodiments, an amount of activation (direct activation or indirect activation) received at node n is compared to a propagation cutoff threshold. Activation is only propagated from node n if the amount of activation received at node n is above the propagation cutoff threshold. In other embodiments, prior to propagating activation along the links connected to node n, the amount of activation proposed to be propagated on each link may be compared to a propagation cutoff threshold. Propagation along a particular link may then occur only if the amount of activation proposed to be propagated on that particular link is greater than the propagation cutoff threshold. In still other embodiments, the thresholding process may involve comparing the link strength of each link to a propagation cutoff threshold whereby propagation may then occur along a particular link only if the link strength of the particular link is above the propagation cutoff threshold. These propagation cutoff thresholding processes may be used in addition or as alternatives to one another.

The propagation of activation in block 23 may be a recursive process because node n may receive activation direct activation 20 and/or indirect activation 21 multiple times in the discrete interval t. The recursive looping of activation propagation may occur at node n and the other nodes of network 10 until the propagation is cutoff by a propagation cutoff thresholding process which may cutoff the propagation of activation at node n or at one of the other nodes of network 10. In the illustrated embodiment, the node strength updates performed in block 26 and discussed below preferably occur at the conclusion of the recursive loops of the block 23 activation propagation.

The node strength of node n is updated at block 26. In the illustrated embodiment, block 26 involves: decreasing the node strength of node n in block 22 in response to the passage of a discrete interval t (which, as discussed above, may involve the passage of time and/or events); and increasing the node strength of node n in block 24 in response to the receipt of activation (i.e. direct activation 20 and/or indirect activation 21) at node n during discrete interval t.

In block 22, the node strength of a node n may be caused to decay by a small amount in each discrete interval t. In some embodiments, the block 22 node strength decay occurs for each node A-H in network 10 every discrete interval t. In other embodiments, the block 22 node strength decay only occurs for nodes which do not receive any direct activation 20 or indirect activation 21 during the discrete interval t. In general, the block 22 node strength decay involves a reduction of the node strength for node n.

Preferably, the block 22 node strength decay does not decrease the node strength of a particular node below a “baseline” node strength. If, it is determined in block 22, that the node strength decay would bring the node strength of node n below its baseline level, then the node strength of node n may be restored to its baseline level. In some embodiments, the block 22 node strength decay is only performed for nodes that are known to have nodes strengths above their baseline levels (i.e. the block 22 node strength decay procedure need not be carried out for nodes which are already at their baseline node strengths). The baseline node strength of a given node may be a constant parameter or a variable parameter. The baseline node strength of a given node may be determined manually (e.g. by user input) or automatically (e.g. by system 12 and/or software 16 which may assign a baseline node strength depending on frequency of access or recency of access to the node, for example).

In some embodiments, the block 22 node strength decay may cause the node strength of node n to decrease in accordance with the function:

w*(n,t):=δ(w(n,t)),

where: δ:[0, 1]→[0, 1]; w(n, t) is the node strength of node n during interval t prior to the block 22 decay; and w*(n, t) is the node strength of node n during interval t after the block 22 decay (but prior to any block 24 increase—discussed below). In one non-limiting example, δ may be given by δ(α):=a·2^{-1/h}^{_{w}}, where the parameter h_{w} determines the amount of node strength decay during a discrete interval t.

Block 24 involves increasing the node strength in response to the receipt of direct activation 20 and indirect activation 21 at node n during the discrete interval t. In general, block 24 involves increasing the node strength of node n, if node n receives direct activation 20 or indirect activation 21. The output node strength of node n after the block 24 node strength increase may depend on the amount of direct activation 20 and indirect activation 21 received by node n. The output node strength of node n after the block 24 node strength increase may be positively correlated with the amount of received activation. In some embodiments, this correlation is a non-linear correlation.

In some embodiments, if node n receives a certain total amount of activation a (including direct activation 20 and indirect activation 21) within a discrete interval t, the node strength of node n may be increased in block 22 in accordance with the equation:

w(n,t+1):=σ(w*(n,t)+α),

where: σ: [symbol] →[0, 1]; w*(n, t) is the node strength of node n in interval t after output of the block 22 node strength decay; and w(n, t+1) is the node strength of node n in the next interval t+1. In one particular non-limiting example, σ may be given by σ(α):=1−exp[−a²/(2(e_{w})²)], where e_{w}ε [symbol] ⁺ is a parameter that determines the relationship between total received activation α in a discrete interval t and the corresponding change in the node strength between the interval t and the interval t+1.

In some embodiments, the output node strength of node n after the block 24 node strength increase is an independent function of the direct activation 20 received and the indirect activation 21 received. In such embodiments, the responsiveness of the function σ causing the block 24 increase in node strength may be differently weighted for direct activation 20 than for indirect activation 21.

In the FIG. 5A embodiment, the block 22 node strength decay (in response to passage of discrete interval t) occurs prior to the block 24 node strength increase (in response to received activation). This is not necessary. In some embodiments, the block 22 node strength decay and the block 24 node strength increase occur at substantially the same time. In other embodiments, the block 22 node strength decay occurs after the block 24 node strength increase or at different points within the discrete interval t. For example, the block 22 node strength decay may occur at the beginning of a discrete interval t and the block 24 node strength increase may occur at the end of the discrete interval t.

FIG. 5B is a schematic block diagram representation of a method 65 for dynamically updating the link strength a particular link w_{nn′} in network 10 in accordance with a particular embodiment of the invention. In some embodiments, method 65 occurs once for each link w_{AB}, w_{AC}, . . . in network 10 in every discrete interval t. In other embodiments, method 65 (or various aspects of method 65) occur(s) more than once in a given discrete interval t.

In accordance with method 65 of FIG. 5B, a link w_{nn′} may receive direct activation 60 in discrete interval t. System 12, software 16 and/or a user may make a decision to provide direct activation to link w_{nn′}. Also, activation may be propagated between nodes A-H of network 10 over links w_{AB}, w_{AC}, . . . (see block 23 of FIG. 5A). In method 65 of FIG. 5B, activation may be propagated over link w_{nn′} in the discrete interval t. Such activation is schematically depicted in FIG. 5B as propagation activation 61. Propagation activation 61 that is propagated over link w_{nn′} may be caused by direct activation or indirect activation received at node n or at node n′ and propagated in either direction therebetween.

The link strength of link w_{nn′} is updated at block 66. In the illustrated embodiment, block 66 involves: decreasing the link strength of link w_{nn′} in block 62 in response to the passage of a discrete interval t (which, as discussed above, may involve the passage of time and/or events); and increasing the link strength of link w_{nn′} in block 64 in response to the receipt of activation (i.e. direct activation 60 and/or propagated activation 61) during discrete interval t.

In block 62, the link strength of a link w_{nn′} may be caused to decay by a small amount in each discrete interval t. In some embodiments, the block 62 link strength decay occurs for each link w_{AB}, w_{AC}, . . . in network 10 every discrete interval t. In other embodiments, the block 62 link strength decay only occurs for links which do not receive any direct activation 60 or propagated activation 61 during the discrete interval t. In general, the block 62 link strength decay involves a reduction of the link strength for link w_{nn′}.

Preferably, the block 62 link strength decay does not decrease the link strength of a particular link below a “baseline” link strength. If, it is determined in block 62, that the link strength decay would bring the link strength of link w_{nn′} below its baseline level, then the link strength of link w_{nn′} may be restored to its baseline level. In some embodiments, the block 62 link strength decay occurs only for links that are known to have link strengths greater than their baseline levels (i.e. the block 62 link strength decay procedure need not be carried out for links which are already at their baseline link strengths). The baseline link strength of a given link may be a constant parameter or a variable parameter. The baseline link strength of a given link may be determined manually (e.g. by user input) or automatically (e.g. by software 16 which may assign a baseline link strength depending on a similarity of the information represented by the corresponding nodes, for example).

In some embodiments, the link strength of a link w, connecting nodes n, n′ may decay according to a function:

assoc*(n,n′,t):=δ(assoc(n,n′,t)),

where: δ: [0, 1]→[0, 1]; assoc(n, n′, t) is a link strength of the link connecting nodes n and n′ in interval t prior to the block 62 decay; and assoc*(n, n′, t) is the link strength of the link connecting nodes n and n′ in interval t after the block 62 decay (but prior to the block 64 link strength increase discussed below). In one particular non-limiting example, δ may be given by δ(s):=s·2^{-1/h}^{_{w}}, where hₐ is a parameter that determines the amount of decay for each discrete interval t.

Block 64 involves increasing the link strength in response to the receipt of direct activation 60 and propagated activation 61 for link w_{nn′} during the discrete interval t. In general, block 64 involves increasing the link strength of link w_{nn′} if link w_{nn′} receives direct activation 60 or propagated activation 61. The output link strength after the block 64 link strength increase may depend on the amount of direct activation 60 and propagated activation 61 received by link w_{nn′} during the interval t. The output link strength after the block 64 link strength increase may be positively correlated with the amount of received activation. In some embodiments, this correlation is a non-linear correlation.

In some embodiments, if link w_{nn′} receives an amount α of activation (including direct activation 60 and indirect activation 61) in the discrete interval t, the link strength of link w_{nn′} may be updated according to the following function:

assoc(n,n,t+1):=ρ(assoc*(n,n′,t),α)

where: ρ: [0, 1]× [symbol] →[0, 1]; assoc*(n, n′, t) is the link strength of link w_{nn′} in interval t after output of the block 62 node strength decay; and assoc(n, n′, t+1) is the link strength of link w_{nn′} in the next interval t+1. In one particular non-limiting example, ρ may be given by ρ(s, α):=1−exp[−(s+α)²/(2(e)²)], where e_{α}ε [symbol] ⁺ is a parameter that determines the relationship between the total received activation a in the interval t and the corresponding change in link strength between the interval t and the interval t+1.

In some embodiments, if a link w_{nn′} receives a certain amount of direct activation 60 and a certain amount of propagated activation 61 in the discrete interval t, then the output link strength after the block 64 link strength increase is an independent function of the direct activation 60 received and the propagated activation 61 received. In such embodiments, the function causing link strength increase may be differently weighted for direct activation 60 received and propagated activation 61 received by link w_{nn′}.

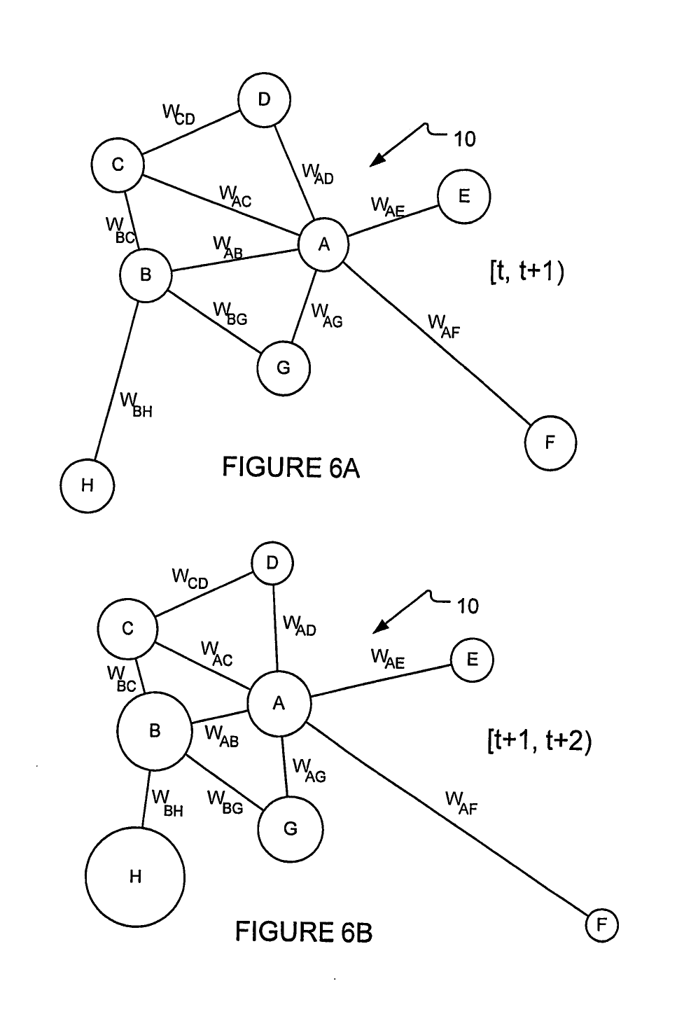

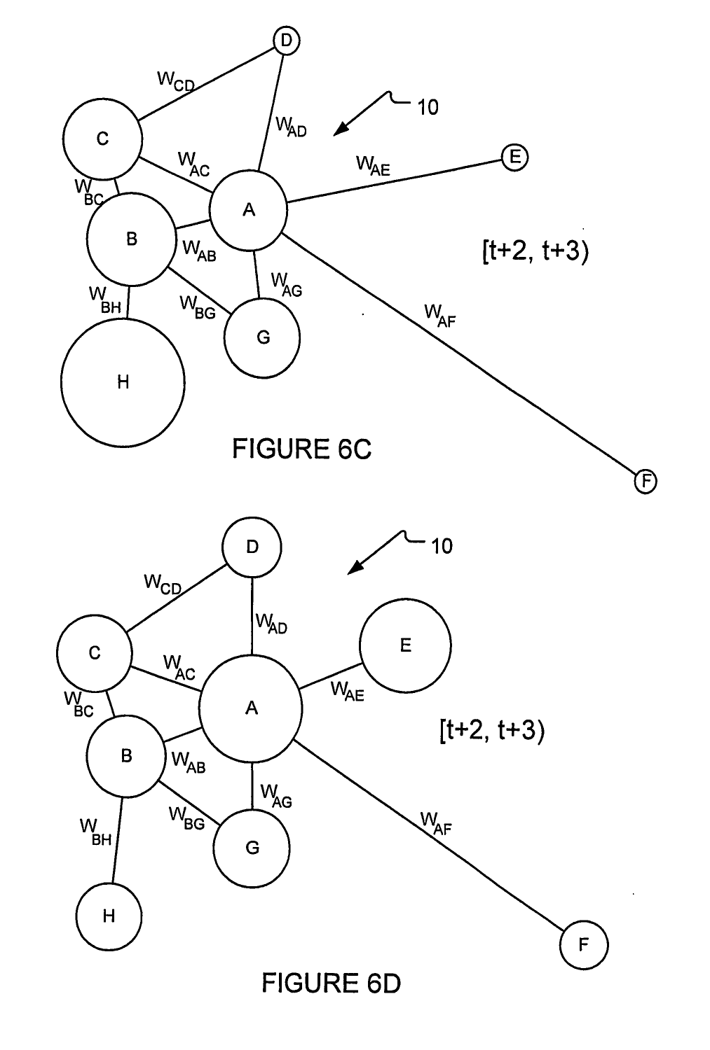

FIGS. 6A-6D schematically depict various states of an exemplary network 10 according to a particular embodiment of the invention. FIGS. 6A-6D illustrate the propagation of activation through network 10 by depicting the state of network 10 during a series of successive discrete intervals. FIG. 6A depicts network 10 at an initial state in the discrete interval [t, t+1) where the square bracket “[” indicates an inclusive range and the round bracket “)” indicates an exclusive range. In the embodiment of FIGS. 6A-6D, the node strengths and link strengths of network 10 are updated at the end of each discrete interval. At conclusion of the interval [t, t+1), the node strengths and link strengths of network 10 are updated and network 10 enters the state shown in FIG. 6B for the period [t+1, t+2). Similarly, at the conclusion of the interval [t+1, t+2), the node strengths and link strengths of network 10 are updated and network 10 enters the state shown in FIG. 6C for the period [t+2, t+3) and at the conclusion of the interval [t+2, t+3), the node strengths and link strengths of network 10 are updated and network 10 enters the state shown in FIG. 6D for the period [t+3, t+4).

In the schematic illustrations of FIGS. 6A-6D: (i) nodes A-H are denoted by circles; (ii) the relative size of the circles denoting nodes A-H represents the relative node strength of their corresponding nodes (i.e. larger circles represent nodes with larger node strengths and smaller circles represent nodes with smaller node strengths); (iii) links w_{AB}, w_{BC} . . . are denoted by lines; and (iv) the relative length of the lines denoting links w_{AB}, w_{BC} . . . represents the relative strength of the corresponding link (i.e. shorter lines represent links with larger link strengths and longer lines represent links with lower link strengths).

In FIG. 6A, network 10 is shown in some initial state in the interval [t, t+1). It can be seen from FIG. 6A that, in interval [t, t+1), nodes A-H all have the same node strength, but some links w_{AB}, w_{AC}, . . . are stronger than others. For example, link w_{AB} has a greater link strength in interval [t, t+1) than link w_{AF}. In the example of FIGS. 6A-6D, it is assumed that node H receives direct activation in the interval [t, t+1). For the purposes of easing explanation, it is assumed that there is no other direct activation created by users, by system 12 or by software 16 in the interval [t, t+1).

At the conclusion of the interval [t, t+1), the node strengths and the link strengths of network 10 are updated and network 10 enters the state shown in FIG. 6B for the interval [t+1, t+2). FIG. 6B shows that the node strength of node H has increased in response to the direct activation that node H received in the interval [t, t+1). FIG. 6B also shows how the node strengths of nodes A, B, C, G have increased in response to the propagation of activation from node H to its neighboring node B (via link w_{BH}) and from node B to its neighboring nodes A, C, G (via links w_{AB}, w_{BC} and w_{BG}). This propagation of activation represents indirect activation received by nodes A, B, C, G.

In the illustrated embodiment, the increase in node strength of node H is greater than the corresponding increases in node strengths of nodes A, B, C, G. This relative difference in node strength increase may occur because the direct activation received by node H is greater than the indirect activation propagated from node H to nodes A, B, C, G. The amount of direct activation received at node H may be greater than the amount of indirect activation that is propagated from node H to node B over link w_{BH}. This difference in activation received by node H and propagated from node H may be related to a propagation decay factor Ω (discussed above). Similarly, the amount of indirect activation received at node B may be less than the amount of indirect activation propagated from node B to nodes A, C, G over links w_{AB}, w_{CB}, w_{GB}.

The relative difference in node strength increase (i.e. between the interval [t, t+1) and the interval [t+1, t+2)) for nodes H and nodes A, B, C, G may have additionally or alternatively occurred because the function for causing an increase in node strength in response to received activation is weighted in favor of direct activation over indirect activation.

FIGS. 6A and 6B also show that the node strength of nodes D, E, F has decayed between the interval [t, t+]) and the interval [t+1, t+2). This node strength decay for nodes D, E, F may have occurred because, between the intervals [t, t+1] and [t+1, t+2), the increase in node strength caused by the propagation of indirect activation from node H to nodes D, E, F was less than the node strength decay for nodes D, E, F. Additionally or alternatively, this node strength decay for nodes D, E, F may have occurred because there was no propagation of indirect activation over links w_{AD}, w_{CD}, w_{AE}, w_{AF} due to the propagation cutoff thresholding process discussed above. In still another alternative, this node strength decay for nodes D, E, F may have occurred because the propagation of indirect activation from node H did not reach nodes D, E, F in the interval [t, t+1).

FIG. 6B also shows how the propagation of activation during the interval [t, t+1) optionally causes corresponding changes in link strength for the interval [t, t+2). Comparing FIG. 6B to FIG. 6A, it can be seen that the strength of link w_{BH} has increased between the intervals [t, t+1) and [t, t+2), as have the link strengths of links w_{BG}, w_{BC} and w_{AB}. In the illustrated embodiment, the increase in link strength of link w_{BH} is greater than the corresponding increases in link strengths of links w_{BG}, w_{BC} and w_{AB}. This relative difference in link strength increase may have occurred because the indirect activation propagated from node H to node B over link w_{BH} is greater than the indirect activation propagated from node B to nodes A, C, G over links w_{AB}, w_{CB}, w_{GB} and/or because the original link strength of link w_{BH} (i.e. prior to the propagation of indirect activation from node H) was greater than the original link strengths of links w_{AB}, w_{CB}, w_{GB}.

FIG. 6B also shows that the strength of links w_{AE} and w_{AF} has decayed between the intervals [t, t+1) and [t, t+2). This link strength decay for links w_{AE} and w_{AF} may have occurred because, between the intervals [t, t+1) and [t+1, t+2), the increase in link strength caused by the propagation of indirect activation over links w_{AE} and w_{AF} was less than the link strength decay for links w_{AE} and w_{AF}. Additionally or alternatively, this link strength decay for links w_{AE} and w_{AF} may have occurred because there was no propagation of indirect activation over links w_{AE}, w_{AF} due to the propagation cutoff thresholding process discussed above. In still another alternative, this link strength decay for links w_{AE} and w_{AF} may have occurred because the propagation of indirect activation from node H did not reach links w_{AE} and w_{AF} in the interval [t, t+1).

In the example of FIGS. 6A-6D, node H receives further direct activation in the interval [t+1, t+2). Once again, as can be seen by comparing FIGS. 6B and 6C, the node strengths of some nodes, such as nodes H, B, A, C, G, have increased between the interval [t+1, t+2) and the interval [t+2, t+3) in response to the receipt of direct activation (in the case of node H) or indirect activation that has propagated from node H (in the case of nodes B, A, C, G). FIGS. 6B and 6C also show that the node strengths of some nodes, such as nodes D, E, F, have decayed between the interval [t+1, t+2) and the interval [t+2, t+3). This node strength decay may have occurred for the same reasons discussed above.

Similarly, FIGS. 6B and 6C show how the link strengths of some links, such as links w_{BH}, w_{BG}, w_{BC}, w_{AB}, have increased because of the propagation of activation over these links. The link strengths of other links, such as links w_{AE} and w_{AF} has decreased between the interval [t+1, t+2) and the interval [t+2, t+3). This link strength decay may have occurred for the same reasons discussed above.

In the example of FIGS. 6A-6D, node E receives direct activation in the interval [t+2, t+3). It can be seen by comparing FIGS. 6C and 6D, that the node strengths of some nodes, such as nodes E, A and F have increased between the interval [t+2, t+3) and the interval [t+3, t+4), while the node strengths of other nodes, such as node H, have decayed. Similarly, the link strengths of some links, such as links w_{AE} and w_{AF}, have increased between the interval [t+2, t+3) and the interval [t+3, t+4), while the link strengths of other links, such as link w_{BH}, have decreased.

In the embodiment described in FIGS. 6A-6D, the node strengths and link strengths of network 10 are updated at the end of a discrete interval and prior to entering the next discrete interval. This is not necessary. In some embodiments, the node and link strengths are updated at different times within a discrete interval t. For example, the node strengths and link strengths of network 10 may be updated at the beginning of a given interval t. In some embodiments, the node strengths and link strengths of network 10 are updated at multiple times during an interval t. Such update times need not be temporally consistent within a discrete interval t. For example, the node strength of a given node may be updated as soon as the node receives direct or indirect activation (i.e. in response to such activation) and the link strength of a given link may be updated as soon as activation has propagated through the link.

Nodes (and the information represented by nodes) may be added to network 10 or deleted from network 10. The addition or deletion of nodes may occur manually (e.g. because system 12 and/or software 16 is instructed by a user to add a node) or automatically (e.g. because system 12 and/or software 16 recognizes that a node should be added to network 10). Nodes may be added (or deleted) from network 10 individually or in groups containing a plurality of nodes. Such groups of nodes may be selected manually or automatically.

When new nodes are added to network 10, new links connecting the new nodes to one another and/or to the previously existing nodes in network 10 may be created by a user or may be created automatically by system 12 and/or software 16.

For example, software 16 may create links between nodes based on: the similarity of the information items 17 represented by the nodes; the similarity of one or more properties of the information items 17 represented by the nodes; and/or usage of the information items 17 represented by the nodes, as discussed above.

Link strengths may be assigned to the links associated with newly added nodes. The assignment of link strengths to the links associated with newly added nodes may be done manually (by a user) or automatically (by system 12 and/or software 16). For example, software 16 may assign link strengths based on the similarity of one or more properties of the information items 17 represented by the corresponding nodes and/or usage of the information items 17 represented by the nodes. The creation of links between nodes and the assignment of link strengths to nodes may be performed by calculating vector distances between nodes or other similarity-determining processes in a manner similar to the similarity-determining processes described in the PCT patent application entitled, PROBABILISTIC AUDIO NETWORKS, which is filed concurrently with this application and which is hereby incorporated by reference herein.

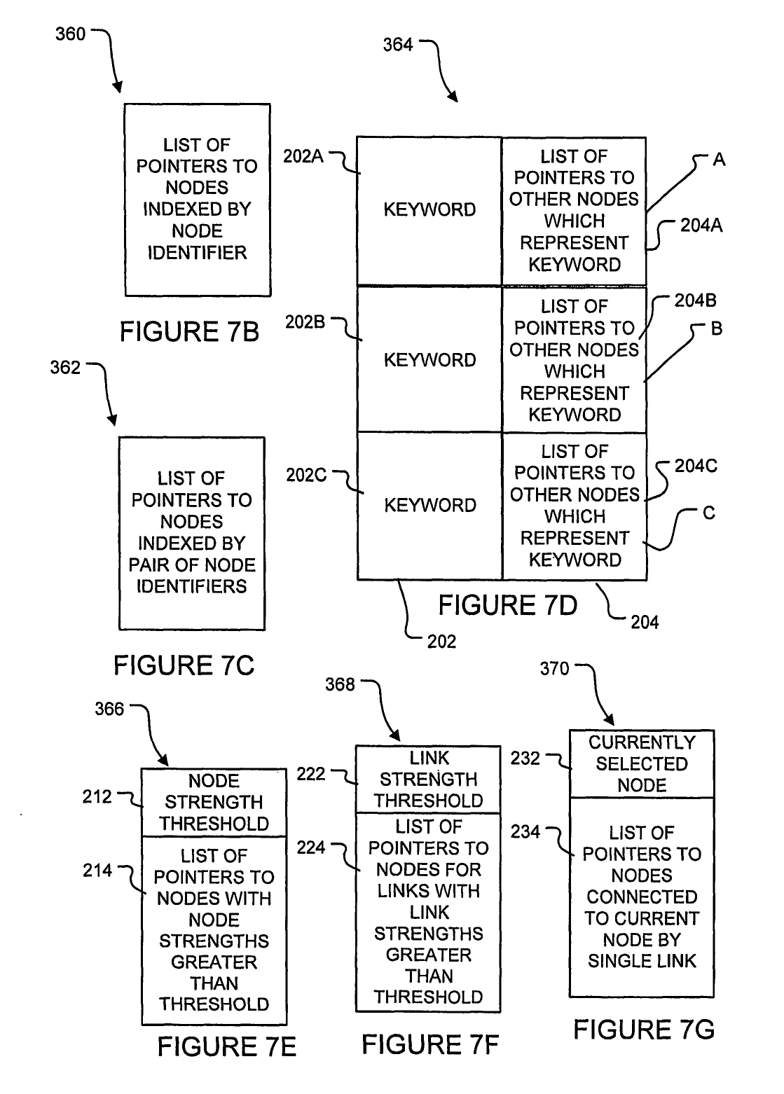

In addition to creating and/or maintaining a network 10 of nodes and links, system 12 and/or software 16 may create and/or maintain additional data structures which may be used to help organize the nodes and links of network 10. Such data structures may take the form of lists or databases or the like. FIG. 7A schematically depicts a number of lists that may be created and/or maintained by system 12 and/or software 16 in accordance with one particular embodiment of the invention. The lists shown in the FIG. 7A embodiment include: node list 360, link list 362, keyword list 364, high-node-strength list 366 and high-link-strength list 368. Node list 360 organizes the nodes of network 10. FIG. 7B is a schematic representation of a data structure that may be used to maintain node list 360. Each entry in node list 360 represents a node in network 10 and the entries of node list 360 may be indexed by the unique node identifier field. Node list 360 comprises a list of pointers to the nodes of network 10. Such pointers may include the unique node identifiers of the network 10 nodes, for example.

Similarly, link list 362 organizes the links of network 10. FIG. 7C is a schematic representation of a data structure that may be used to maintain link list 362. Each entry in list 362 represents a link in network 10 and comprises pointers to a pair of nodes that are connected by the link. The entries of list 362 may be indexed by the pair of unique identifiers corresponding to the two nodes to which the links are connected. In alternative embodiments, link data structures are provided with their own unique identifier field which may be used to index link list 362.

System 12 and/or software 16 may also create and maintain one or more lists based on characteristics or properties of the information items 17 represented by the nodes of network 10. In the FIG. 7A embodiment, system 12 incorporates a keyword list 364. FIG. 7D schematically depicts a data structure corresponding to keyword list 364. For simplicity, in the illustrated embodiment of FIG. 7D, keyword list 364 comprises only three entries (A, B, C). In general, however, a keyword list used in accordance with the invention may contain many more than three entries. Keyword list 364 is indexed by a keyword field 202 (i.e. each entry A, B, C in keyword list 364 corresponds to one keyword or one combination of keywords 202A, 202B, 202C). Keyword list 364 is actually a list of lists 204. Each entry A, B, C in keyword list 364 also comprises a corresponding list 204A, 204B, 204C of pointers (e.g. unique node identifiers) to nodes which incorporate the corresponding index keyword (or keyword combination) 202A, 202B, 202C. Such nodes may have the index keyword (or keyword combination) 202A, 2002B, 202C in their keyword field 308, 328 (see FIGS. 3A, 3B).

In some embodiments, system 12 and/or software 16 create and maintains one or more dynamic lists. In the FIG. 7A embodiment, system 12 and/or software 16 maintain a dynamic high-node-strength list 366 which represents a list of nodes having node strengths above a certain threshold level. FIG. 7E shows a data structure corresponding to a high-node-strength list 366. As shown in FIG. 7E, high-node-strength list 366 comprises: a node-strength threshold 212 (which may be user-defined or defined by system 12 and/or software 16); and a list 214 of pointers to nodes which have node strengths that are greater than the threshold 212. In some embodiments, high-node-strength list 366 is sorted according to node strength. In some embodiments, a threshold node strength level is not required and high-node-strength list 366 may be implemented as a sorted list containing pointers to a fixed number (or user-configurable number) of nodes in network 10 with the highest node strengths. In some embodiments, high-node-strength list 366 contains a list of all of the nodes of network 10 sorted by node strength.

Another example of a dynamic list which may be created and/or maintained by system 12 and/or software 16 is a high-link-strength list 368 (FIG. 7A). FIG. 7F schematically depicts a data structure corresponding to a high-link-strength list 368 according to a particular embodiment of the invention. As shown in FIG. 7F, high-link-strength list 368 comprises: a link-strength threshold 222 (which may be user-defined or defined by system 12 and/or software 16); and a list 224 of pointers to nodes corresponding to links which have link strengths that are greater than the threshold 222 (i.e. list 224 comprises pointers to two nodes for each entry). In some embodiments, high-link-strength list 368 is sorted according to link strength. Like high-node-strength list 366, in some embodiments, a threshold link strength level is not required and high-link-strength list 368 may be implemented as a sorted list containing a fixed number (or user-configurable number) of links in network 10 with the highest link strengths. In some embodiments, high-link-strength list 368 contains a list of all of the links of network 10 sorted by link strength.

Another example of a dynamic list which may be created and/or maintained by system 12 and/or software 16 is a connected-node list 370 (FIG. 7A). FIG. 7G schematically depicts a data structure corresponding to a connected-node list 370 in accordance with a particular embodiment of the invention. As shown in FIG. 7G, connected-node list 370 comprises: a currently-selected node 232; and a list 234 of pointers to nodes which are connected to the currently-selected node 232 via a single link. In some embodiments, connected-node list 370 is sorted according to the node strength of the connected nodes in list 234 or according to the link strength of the links connecting the connected nodes in list 234 to the currently-selected node 232. In other embodiments, rather than only listing nodes that are separated from the currently-selected node 232 by a single link, connected-node list 370 incorporates nodes that are separated from the current node by fewer than a threshold number of links.

Other types of lists (not shown in FIG. 7A) may be created and/or maintained by system 12 and/or software 16. For example, lists may be created and/or maintained on the basis of the recency of user access to (or selection of) particular nodes or on the basis of other similarities between one or more properties of the information items 17 represented by the particular nodes. System 12 and/or software 16 may automatically create lists like those shown in FIG. 7A. In addition or in the alternative, lists like those shown in FIG. 7A may be created by a user. When a list is created or nodes are added to an existing list, system 12 and/or software 16 may automatically: create links between nodes on the list; increase the link strengths of the links between the nodes on the list; and/or increase the node strength of nodes on the list.

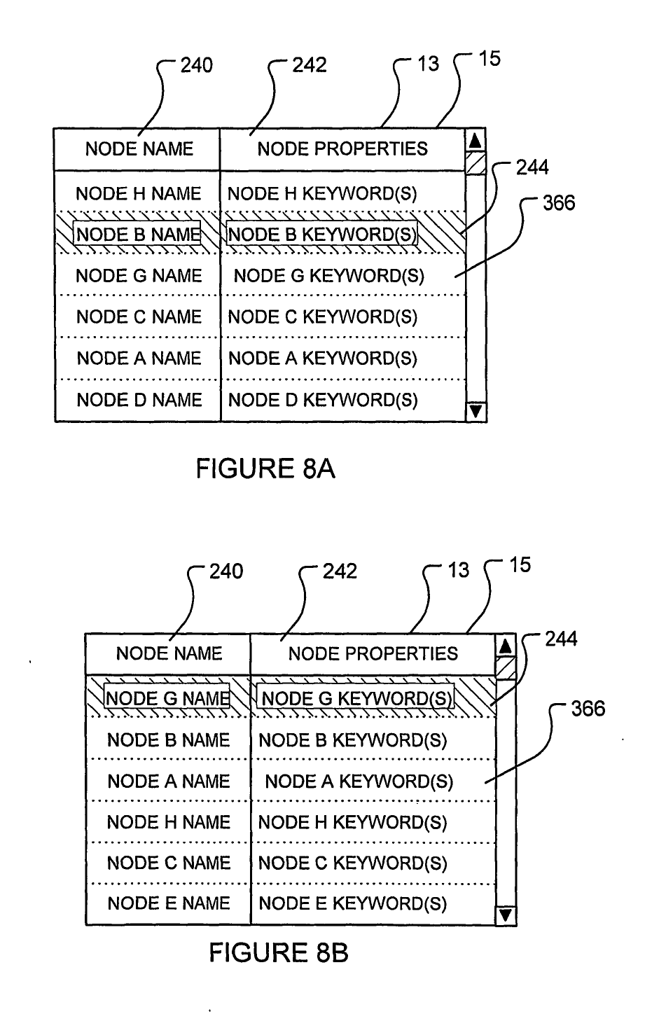

System 12 and/or software 16 may use the lists 362, 364, 366, 368, 370 shown in FIG. 7A (or similar lists) as the basis of, or part of, user interface 15 (FIG. 1). In accordance with one particular embodiment shown schematically in FIG. 8A, system 12 and/or software 16 causes some indicia capable of identifying the nodes on high-node-strength list 366 or their corresponding information items 17 to be displayed on user interface 15. Preferably, the displayed indicia allow a user to identify the information item 17 represented by a content node and/or the property represented by a property node. The indicia may be graphical, textual or some combination thereof. By way of non-limiting example, high-node-strength list 366 and may be displayed on user interface 15 in the form of a graphical toolbar-type display or the like.

Through user interface 15, a user may cause one of the nodes on the displayed list to be the currently-selected node and to receive direct activation as discussed above. This may be accomplished, for example, by selecting the indicia that identifies the information item 17 corresponding to the node and providing some indication that increased activation is requested for that indicia. A user may also access an information item 17 corresponding to one of the nodes on the displayed list by selecting the indicia that identifies the information item 17 and providing some indication that access to the information item is required. In general, as used herein, “accessing” an information item 17 should be considered to include any manner of using the data contained in information item 17. By way of non-limiting example, accessing an information item 17 comprising a document includes opening the document and accessing an information item 17 comprising media content includes playing back the media content. Accessing an information item 17 may (but need not necessarily) involve providing direct activation to the node corresponding to the information item 17.

In the FIG. 8A embodiment, user interface 15 shows the name field 303, 323 (FIGS. 3A, 3B) of the nodes on list 366 in a node name column 240 and the keyword(s) 308, 328 (FIGS. 3A, 3B) associated with each of the nodes on list 366 in a node properties column 242. This display of the node name and keyword fields provides indicia which allow a user to identify the information items 17 represented by the respective content nodes in list 366 and the properties represented by the respective property nodes in list 366. It will be appreciated that in other embodiments, user interface 15 may display other indicia relating to the nodes on list 366. For example, the last update time stamp field 310, 330 (FIGS. 3A, 3B) of the nodes on list 366 or information from any of the other fields of the data structures 300, 320 corresponding to the nodes on list 366 may also be displayed.

A user may select a node from high-node-strength list 366 to be the currently-selected node 244 by selecting the indicia corresponding to an information item 17 whose node is on high-node-strength list 366 and providing some indication that activation is desired. Selecting a node to be the currently-selected node 244 may (but need not necessarily) involve accessing the information item 17 corresponding the currently-selected node 244. For example, if the information item 17 corresponding to the currently-selected node 244 represents a file, then selecting the currently-selected node 244 may (but need not necessarily) involve opening the file. Similarly, a user may access the information items 17 represented by the nodes on high-node-strength list 366 by selecting the indicia corresponding to an information item 17 whose node is on high-node-strength list 366 and providing some indication that access to the information item 17 is desired. For example, a user may open a file by selecting the indicia corresponding to the file from the high-node-strength list and providing some indication that the file should be opened (e.g. by left clicking a mouse and choosing an option call “open”). Accessing the information item 17 corresponding to a particular node may (but need not necessarily) involve selecting that node to be the currently-selected node (i.e. providing activation to the node). Preferably, as shown in FIG. 8A, currently-selected node 244 is highlighted or the user is otherwise provided with some indication of currently-selected node 244. In the FIG. 8A embodiment, node B is the currently-selected node 244. Preferably, high-node-strength list 366 is sorted by node strength. In the FIG. 8A embodiment, node H has the highest node-strength, followed by the currently-selected node 244 (node B) and then nodes G, F, A, D.

FIG. 8B shows the changes in high-node-strength list 366 displayed by user interface 15 after node G is selected to be the currently-selected node 244. It is assumed for the purposes of explaining FIG. 8B, that network 10 is the network shown in FIG. 2. The selection of node G to be the currently-selected node 244 causes node G to receive direct activation and causes indirect activation to be propagated from node G through the links of network 10 to the other nodes as discussed above. As shown in FIG. 8B, node G becomes the node with the highest node strength and therefore moves to the top of high-node-strength list 366. Node A, which is connected to node G via a single link WAG, also moves up high-node-strength list 366 because of the indirect activation received at node A via link WAG.

Other changes in high-node-strength list 366 include: the downward movement of node H; the introduction of node E to list 366; and the removal of node D from list 366. The downward movement of node H within list 366 may have occurred because node H is two links away from node G and therefore does not receive as much indirect activation as nodes A and B and/or because the link strength of link w_{BG} is relatively low. Node E may have been added to list 366 because it received enough indirect activation from node G to get over the threshold required to be included on high-node-strength list 366. Node D may have been removed from high-node-strength list because the decay of its node strength was greater than the increase in node-strength caused by the indirect activation that it received from node G and, consequently, it fell below the node strength threshold required for inclusion on list 366.

FIGS. 8A and 8B show that the nodes related to the currently-selected node 244 (e.g. linked by a fewer number of links and/or by links having relatively high link strengths) are likely to receive indirect activation and, therefore, are likely to have relatively high node-strengths when compared to the other nodes in network 10. Consequently, such nodes are likely to be on high-node-strength list 366 and/or move toward the top of high-node-strength list 366. In this manner, displaying high-node-strength list 366 on user interface 15 and providing the user with the ability to access the information items 17 represented by the nodes on high-link-strength list 366 allows a user to efficiently and quickly access information items 17 that are related to the information item 17 associated with the currently-selected node 244.

Other criteria may be used to refine the high-node-strength list 366 displayed on user interface 15. In some embodiments, a user may provide system 12 and/or software 12 with a query that limits the type of nodes displayed on user interface 15. Such a query may relate to the properties of the information items 17 represented by the nodes in network 10. These properties may be contained in the various fields of the data structures 300, 320 corresponding to the nodes in network 10. By way of non-limiting example, a user may input a keyword query to system 12. The high-node-strength list 366 displayed on user interface 15 may then only list nodes which have the keyword query in their keyword fields 308, 328. It should be noted that such a query need not necessarily alter the contents of high-node-list 366, but may only influence which of the nodes in high-node-strength list 366 are displayed on user interface 15. Another non-limiting example of a query that could be used in this manner is a recently accessed query, where the nodes on high-node-strength list 366 would only be displayed on user interface 15 if they had been accessed within the queried interval.

The properties of the information items 17 corresponding to the nodes in network 10 may additionally or alternatively be used to influence the high-node-strength list 366 by forming the basis for providing direct activation to certain nodes and thereby moving the nodes exhibiting such properties toward the top of high-node-strength list 366. For example, a user may input one or more keyword(s) on user interface 15. System 12 and/or software 16 could use such keyword(s) to provide direct activation to all nodes having the keyword(s) in their corresponding keyword fields 308, 328. Providing this direct activation would tend to move the nodes having the keyword(s) in their corresponding keyword fields 308, 328 toward the top of high-node-strength list 366 that is displayed on user interface 15.

Property nodes may also be used for a similar purpose. In one embodiment, a user may select a property node that is listed on high-node-strength list 366 or otherwise shown on user interface 15 to be the currently-selected node (or through some other means of selection). Selection of a content node may introduce direct activation to the property node, which is then propagated to all of the nodes exhibiting that property. The nodes exhibiting that property may be the nodes from field 326 of the property node data structure (see FIG. 3B).

In some embodiments, the high-node-strength list 366 displayed on user interface 15 may be configured to display only content nodes or only property nodes. In some embodiments, property nodes may be displayed on a separate list or the like which may be used for selection of property nodes.

The display and use of high-node-strength list 366 on user interface 15 shown in FIGS. 8A and 8B and discussed above represent the use of only one of the lists 360, 362, 364, 366, 368, 370 shown in FIG. 7A. Those skilled in the art will appreciate that other lists maintained by system 12 and/or software 16 may be used in a similar manner to provide other similar advantages. When displayed, the contents of the list may be sorted by the node strengths of the listed nodes, by the link strengths of the listed links or both. By way of non-limiting example, where a connected-node list 370 is displayed on user interface 15, a user will have a list of all of the nodes that are connected to the currently-selected node. The nodes listed in the connected-node list are likely to be similar or related to the currently-selected node. A user may then “follow a link” in network 10 by selecting one of the nodes in the connected-node list 370. As another non-limiting example, user interface 15 can display information obtained from keyword list 364. A user may be able to input a keyword query via any suitable input device 11. When displayed, keyword lists 362 may be sorted by node strength of the corresponding nodes or by similarity of the keyword query to the keywords contained in keyword fields 308, 328 of the corresponding nodes or both.

While the above techniques describe methods of using lists 360, 362, 364, 366, 368, 370 for displaying certain aspects of nodes and allowing users to select a node to be the currently-selected node, such techniques are not exclusive. In some embodiments, a user may navigate from any currently-selected node to any other node in network 10 and may select that other node to be the new currently-selected node regardless of node strength, link strength or the presence of common keywords or links between the currently-selected node and the new currently-selected node.

Preferably, a user provides system 12 and/or software 16 with an indication of whether navigation through nodes (or otherwise selecting nodes or accessing the information items 17 corresponding to nodes) should alter the node strengths of the selected/accessed nodes and cause corresponding propagation of activation through links to neighboring nodes as described above or whether navigation through nodes (or otherwise selecting nodes or accessing the information items 17 corresponding to nodes) should be prevented from causing activation propagation. Such an indication from a user may be in the form of a toggle input, for example.

Selecting a particular node (node A for example) to be the currently-selected node may cause a number of other changes in network 10 and/or to node A. By way of non-limiting example, selecting node A to be the currently-selected node may cause a change to the last update time stamp associated with node A (see fields 310, 330 of FIGS. 3A, 3B). Selecting node A to be the currently-selected node may also cause system 12 and/or software 16 to create a link between node A and a previously selected node (i.e. a node selected within a threshold number of selections prior to the selection of node A as the currently-selected node) and/or a subsequently selected node (i.e. a node selected within a threshold number of selections after the selection of node A as the currently-selected node). If such links already exist, system 12 and/or software 16 may increase the link strength of the links between such nodes.

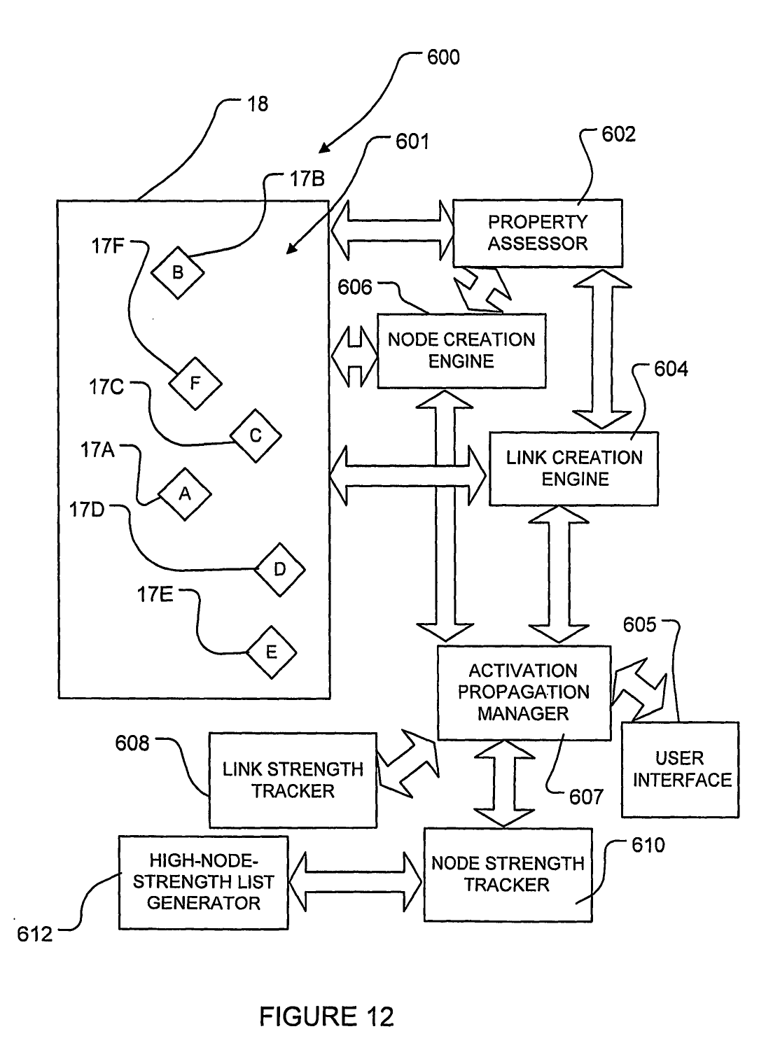

FIG. 12 is a schematic illustration showing other aspects of a system 600 which may be used to create and maintain the networks described herein. System 600 comprises a set 601 data items 17 contained in data storage 18. A node creation engine 606 recognizes the data items 17 and creates content nodes corresponding to the data items. In the illustrated embodiment, system 600 incorporates an optional property assessor 602 which analyzes data items 17 and attempts to determine properties of the data items. In some embodiments, property assessor 602 receives input from external sources (not shown), such as input from user(s) which may come via user interface 605, from database(s) relating to information items 17, from the internet or the like. Node creation engine 606 may also create property nodes using information from property assessor 602. When creating property nodes or content nodes, node creation engine 606 may also receive input from external sources. System 600 also comprises link creation engine 604, which may receive information from any of: information items 17A-17E, property assessor 602 and external sources. This information comprises relevance information (e.g. similarity information) between the nodes created by node creation engine 606. Link creation engine 604 uses this information to establish links between the nodes created by node creation engine 606.

System 600 also comprises an activation propagation manager 607 that receives information from user interface 605 (i.e. a user has accessed an information item 17 and/or a user has caused a node to be the currently-selected node). Activation propagation manager 607 then controls the flow of activation through the network created by node creation engine 606 and link creation engine 604. Link strength tracker 608 and node strength tracker 610 receive information from activation propagation manager 604 and update the strengths of the links and nodes as discussed above. In the FIG. 12 embodiment, system 600 comprises a high-node-strength list generator 612, which maintains a high-node strength list (as described above) using information from node strength tracker 610. Although not shown in FIG. 12, the information maintained by high-node-strength list generator 612 is preferably output to user interface 605 to provide indicia of the information items 17 that correspond to nodes having the highest node strengths. These nodes will tend to represent the most relevant information for the user in the context of the user's current activities. In other embodiments, system 600 may comprise additional or alternative list generators which maintain one or more of the other types of lists discussed above.

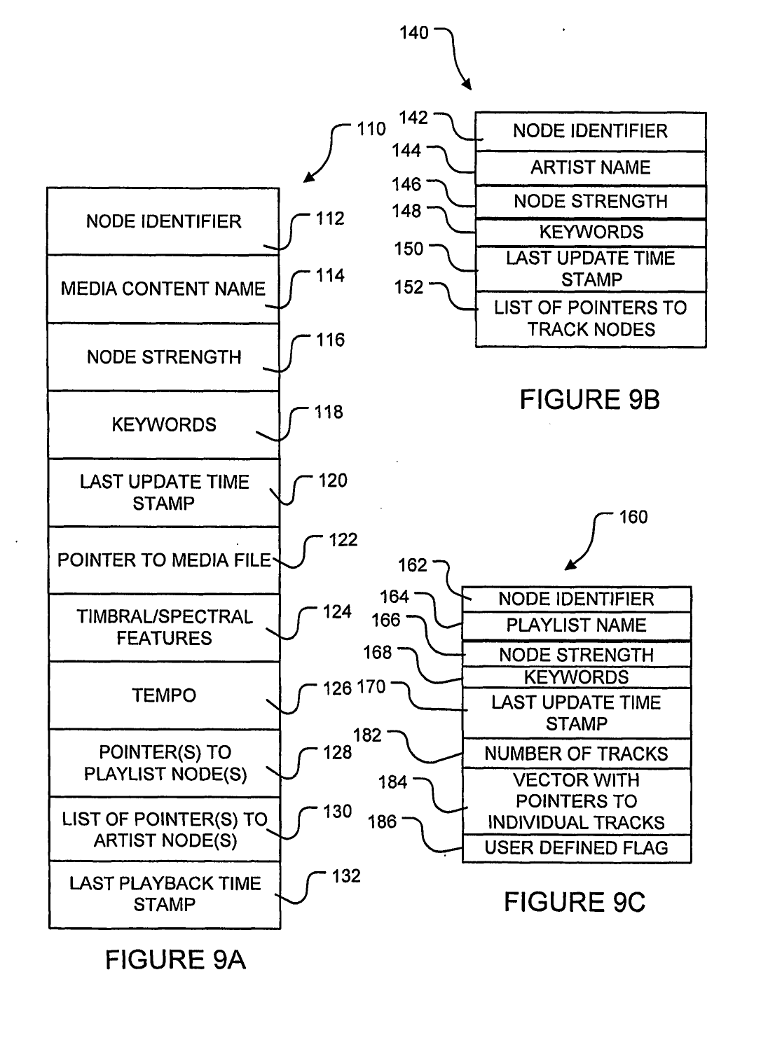

A specific example is now provided to illustrate some of the features of the invention within the context of a particular embodiment. This exemplary application is merely intended to be an example of a possible application of the invention and as an explanatory aid to assist with describing the invention and is specifically not intended to limit the scope of the invention. System 12 may be a media playback system, such as a home stereo, a commercial stereo, a portable music player, or the like, for example.

Where system 12 is a media playback system, information items 17 comprise media content. Accordingly, the content nodes of network 10 represent media content information items 17. FIG. 9A schematically depicts a data structure 110 which may be used to represent a media content node. Data structure 110 comprises fields corresponding to:
a node identifier 112 which uniquely identifies data structure 110 and its corresponding node;
a media content name 114;
a node strength 116;
keywords 118 which describe the media content or the media content's characteristics (e.g. metadata such as the genre and/or artist of the media content, keywords in the media content name 114 and/or other words which describe the media content);
a last update time stamp 120 indicating the last time that the node strength of the corresponding node was updated;
a pointer 122 to the media file which contains the actual media content;
timbral/spectral properties 124 of the media content for the case where the media content is audio content. Such properties may be automatically determined by system 12 and/or software 16 or may be downloaded (or otherwise obtained) from an external source, such as a database or an external media analyzer or the like;
tempo 126 of the media content for the case where the media content is audio content. Tempo information may be automatically determined by system 12 and/or software 16 or may be downloaded (or otherwise obtained) from an external source, such as a database or an external media analyzer or the like;
a pointer 128 to an album corresponding to the media track (if such an album exists);
a list of pointer(s) 130 to one or more artist node(s) representing the artist(s) that contributed to the creation of the media content—artist nodes are discussed in more detail below; and
a last playback time stamp 132 which represents the last time that the media content was played back by system 12.

Where system 12 is a media playback system, one example of a property node is an artist node. An artist node may represent a person (or group of people) who may have contributed to one or more of the media content information items 17 accessible to system 12. FIG. 9B depicts an artist data structure 140 in accordance with a particular embodiment of the invention. Artist data structure 140 comprises fields corresponding to:
a node identifier 142 which uniquely identifies data structure 140 and its corresponding node;
a name 144 of a particular artist;
a node strength 146;
keywords 148 which describe the artist or the artist's characteristics (e.g. the artist's name, the media genre(s) that the artist creates, nicknames of the artist, related artists names, names of media content created by the artist or the like);
a last update time stamp 150 indicating the last time that the node strength of the corresponding node was updated; and
a list 152 of pointers to media content nodes which represent media content performed by the artist in field 144.

Another type of property node that may be used in a media playback system is a playlist node. In general, a playlist is a list of media files that are grouped together (e.g. for playback in a certain order). A playlist may be a user-defined playlist or a pre-determined playlist, such as an album of media files produced by a particular artist, for example. FIG. 9C depicts a playlist data structure 160 in accordance with a particular embodiment of the invention. Playlist data structure 160 comprises fields corresponding to:
a node identifier 162 which uniquely identifies data structure 160 and its corresponding node;
a name 164 of a particular playlist;
a node strength 166;
keywords 168 which describe the playlist or the characteristics of the playlist (e.g. genre(s) of media listed in the playlist, nicknames of the playlist, the name 164 of the playlist, the artists with media listed in the playlist or other descriptive keywords);
a last update time stamp 170 indicating the last time that the node strength of the corresponding node was updated;
a number 182 of tracks in the playlist;
a vector 184 comprising pointers to the individual media content nodes representing the media content on the playlist; and
a flag 186 which indicates whether the playlist is a user-defined playlist or a predetermined playlist.

As discussed above, links w_{AB}, w_{AC}, . . . between nodes A-H of network 10 may represent relevance relationships between the nodes. Preferably, network 10 comprises links w_{AB}, w_{AC}, . . . between nodes which share one or more common or similar properties. In the case where system 12 is a media playback system, non-limiting examples of links include: a link for connecting a pair media content nodes corresponding to two media tracks that are similar to one another (e.g. two audio tracks that have the same or similar artist(s), two audio tracks that have the same or similar musical genre(s), two audio tracks that have the same or similar timbral/spectral properties and/or two audio tracks that have similar tempos); a link for connecting a media content node to an artist node representing the artist who created the media content; and a link for connecting a media content node to a node representing a playlist on which the media content is listed. Those skilled in the art will appreciate that there are many other links which can be envisaged for media playback systems on the basis of the similarity of the properties of the information represented by their corresponding nodes.

As discussed above, links between the nodes of network 10 may be created manually or automatically. Automatic link creation may be based on: the similarities between properties of media content nodes and/or their corresponding media content information items; and/or the similarities between the property represented by a property node and the properties of a media content node. By way of non-limiting example, a media playback system 12 and/or its associated software 16 may create a link between a pair of nodes (such as nodes A and D) because: nodes A and D represent musical tracks that have highly similar timbral/spectral properties; nodes A and D represent musical tracks that have similar tempos; nodes A and D represent media tracks that have similar keywords (e.g. mood-related keywords, such as relaxing, happy or sad; or genre-related keywords, such as action, drama, romantic comedy or rap, classical, rock); node A represents an artist and node D represents a media track created by that artist; and/or node A represents a playlist and node D represents a media track listed in the node A playlist. Properties of a media track, an author or a playlist, such as timbral/spectral properties, mood-related keywords, genre-related keywords, tempo, or other properties, may be obtained by (or otherwise provided to) system 12 via user input, via access to databases containing media information and/or by using audio analysis software, for example.

Links between nodes may also be automatically created in media playback system 12 on the basis of usage. System 12 and/or software 16 may observe a relationship between the usage of two nodes A and D and may automatically create link w_{AD} on the basis of this usage relationship. For example, if nodes A and D represent media content nodes, a user may play back the content represented by node A followed by the content represented by node D or may play back the content represented by both nodes A and D within a certain threshold interval. This threshold interval may be monitored using the last playback time stamp field 132 (FIG. 9A). The threshold interval need not be a temporal interval and may be a number of discrete intervals t.

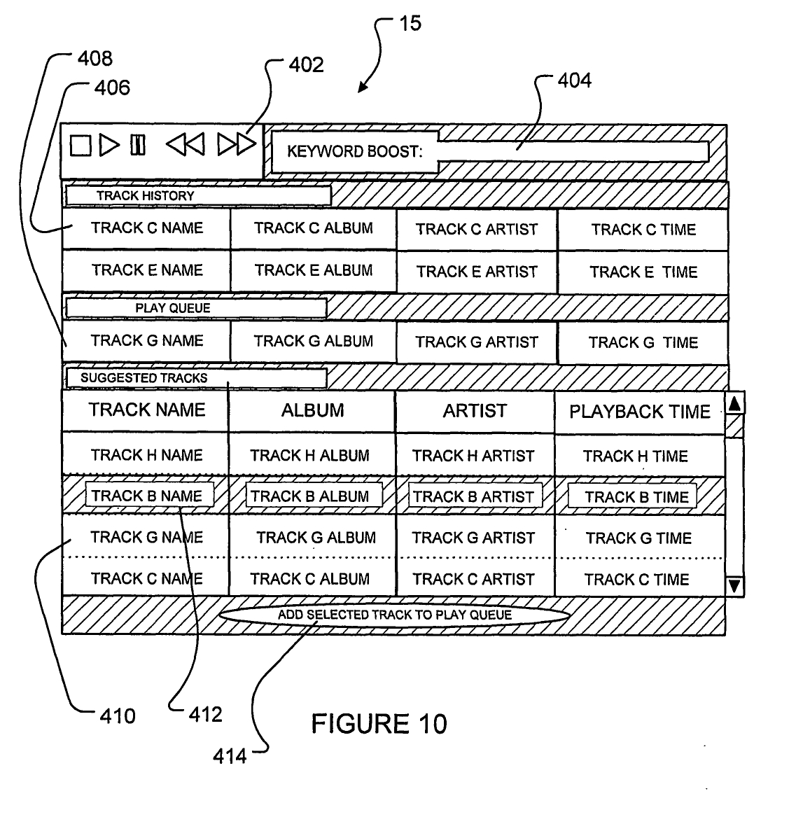

FIG. 10 is a schematic description of a portion of a user interface 15 which may be used in connection with a media playback system 12. User interface 15 comprises: some control inputs 402; a keyword boost input bar 404; a track history list 406; a playback queue 408; and a suggested tracks list 410. Control inputs 402 may comprise media playback system controls which are common to most media playback systems and which are familiar to those skilled in the art. Non-limiting examples of such controls include: a volume control; a playback control; sequential or random playback toggle; a pause control and the like.

Track history list 406 may comprise a list of recently played back tracks. In the FIG. 10 example, track history list 406 shows the tracks corresponding to nodes C and E. Although the length of track history list 406 (i.e. the number of tracks in track history list 406) may be constant, the number tracks in track history list 406 may be different than two. In some embodiments, the length of track history list is a temporal length (i.e. rather than a constant number of tracks or a constant number of discrete intervals) and, as a result, the number of tracks in track history list 406 will vary.

The suggested tracks list 410 may be implemented by a high-node-strength list of the type discussed above. In the FIG. 10 embodiment, the node corresponding to track H has the highest node strength followed by nodes corresponding to tracks B, G and C. A user may provide direct activation to the node corresponding to any track shown on list 410 (i.e. select the node to be the currently-selected node) by selecting the indicia corresponding to that track on the list 410 and providing some indication that activation should be provided to the corresponding node (e.g. a left mouse click and selecting the option “activate”). In the FIG. 10 embodiment, the user has selected track B to be the currently-selected node 412. Selection of node B to be the currently-selected node 412 causes direct activation to be received by node B and a corresponding increase in the node strength of node B. Selection of node B to be the currently-selected node 412 also causes indirect activation to be propagated from node B to the neighboring nodes in network 10 via the links in network 10 as discussed above. In this manner, nodes that may be related to node B (or otherwise linked to node B) receive indirect activation and their node strengths are also increased. These increases in node strength cause node B and the nodes related to node B (or otherwise linked to node B) to move toward the top of the high-node-strength list that forms the basis of suggested tracks list 410.

In the FIG. 10 embodiment, a user can reorder the suggested tracks list 410 using the keyword boost field 404. To do this, the user enters a keyword or keyword combination into keyword boost field 404. System 12 and/or software 16 uses the keyword(s) entered in field 404 to provide direct activation to all nodes having such keyword(s) in their corresponding keyword fields 118, 148, 168 (FIGS. 9A, 9B, 9C). This direct activation is propagated through network 10 as discussed above. Providing this direct activation would tend to move the nodes having the keyword(s) in their corresponding keyword fields 118, 148, 168 toward the top of the high-node-strength list 366 that forms the basis of suggested tracks list 410. This direct activation will then be propagated through network 10 causing an increase in the node strengths of other related nodes (i.e. nodes connected via links to the node having the entered keyword(s) in their corresponding keyword fields 118, 148, 168) and causing these related nodes to move toward the top of the high-node-strength list 366 that forms the basis of suggested tracks list 410.

In a specific example, a user may hear a song that they enjoy. The user may see from play queue 408 that the song is from the album entitled “Dark Side of the Moon”. The user may then enter “Dark Side of the Moon” into the keyword boost field 404. In accordance with the FIG. 10 embodiment, all of the media content nodes having “Dark Side of the Moon” in their respective keyword fields 118 would receive direct activation. This direct activation would tend to move tracks from the Dark Side of the Moon album toward the top of suggested track list 410. The Dark Side of the Moon playlist/album node (i.e. a playlist node having Dark Side of the Moon in its keyword field 168) may also receive direct activation.

In addition, the artist of the Dark Side of the Moon album may be Pink Floyd. The Pink Floyd artist node may have Dark Side of the Moon in its keyword field 148 and thereby receive direct activation. Additionally or alternatively, the Pink Floyd artist node could be connected via a link to one or more of the content nodes representing tracks from the Dark Side of the Moon album or to the Dark Side of the Moon playlist/album node. In such a circumstance, indirect activation would be propagated to the Pink Floyd artist node.

Any of the nodes representing tracks from the Dark Side of the Moon album, the Dark Side of the Moon playlist/album node and/or the Pink Floyd artist node may be connected (via links) to other media content nodes representing tracks created by Pink Floyd (i.e. having Pink Floyd in their artist field 130). In this manner, indirect activation would then also be propagated from any of the nodes representing tracks from the Dark Side of the Moon album, the Dark Side of the Moon playlist/album node and/or the Pink Floyd artist node to other media content nodes having Pink Floyd in their artist field 130. This would increase the node strength of the nodes representing the other tracks by Pink Floyd and cause these nodes to move toward the top of the high-node-strength list 366 that forms the basis of the suggested tracks list 410.

Some of the nodes that receive direct activation may also be connected via links to nodes representing other tracks which do not have Pink Floyd as the artist. For example, one of the nodes representing a track from the dark Side of the Moon album may be connected to anode representing another track via a link because the two tracks share similar spectral properties (field 124 of FIG. 9A). Indirect activation from the keyword boost may be propagated to the node representing this other track and, consequently, its node strength may be increased and it too may move toward the top of the high-node-strength list 366 that forms the basis of the suggested tracks list 410.

In this manner, the keyword boost field 404 may cause activation to propagate through network 10 and thereby influence the tracks shown on the suggested track list 410 and the located of such tracks within the suggested track list 410.

In the FIG. 10 embodiment, a currently-selected track 412 need not correspond with the track currently being played back by system 12. Selection of a track from suggested track list 410 and providing an indication that the node corresponding to the track should receive activation may cause the selected track to become the currently-selected track 412 and to receive direct activation as discussed above. A user may also cause one or more tracks from suggested track list 410 to be added to play queue 408 using an add to play queue input 414. Add to play queue input 414 may generally be any suitable type of input. In some embodiments, adding a track to play queue 408 using input 414 is distinct from selecting a track to be the currently-selected track 412. In other embodiments, adding a track to play queue 408 using input 414 causes that track to become a currently-selected track 412 or vice-versa. Tracks added to play queue 408 need not be played right away and may stay in play queue 408 for subsequent playback. Playing back a track and/or adding the track to the play queue 408 may involve accessing the information item 17 corresponding to the track.

In the FIG. 10 example, playback queue 408 has only a single track (corresponding to node G), but playback queue 408 may generally contain a number of tracks which may be added one at a time or in groups using input 414. As discussed above, the addition of a track to play queue 408 may cause direct activation of the node corresponding to that track and corresponding propagation of that activation through network 10. If so, a user can use suggested track list 410 to create a custom playback list of related tracks on the fly. This custom playback list may be shown in playback queue 408. System 12 may be caused to play back the track(s) in playback queue 408 at any time after one or more tracks have been added to playback queue 408.

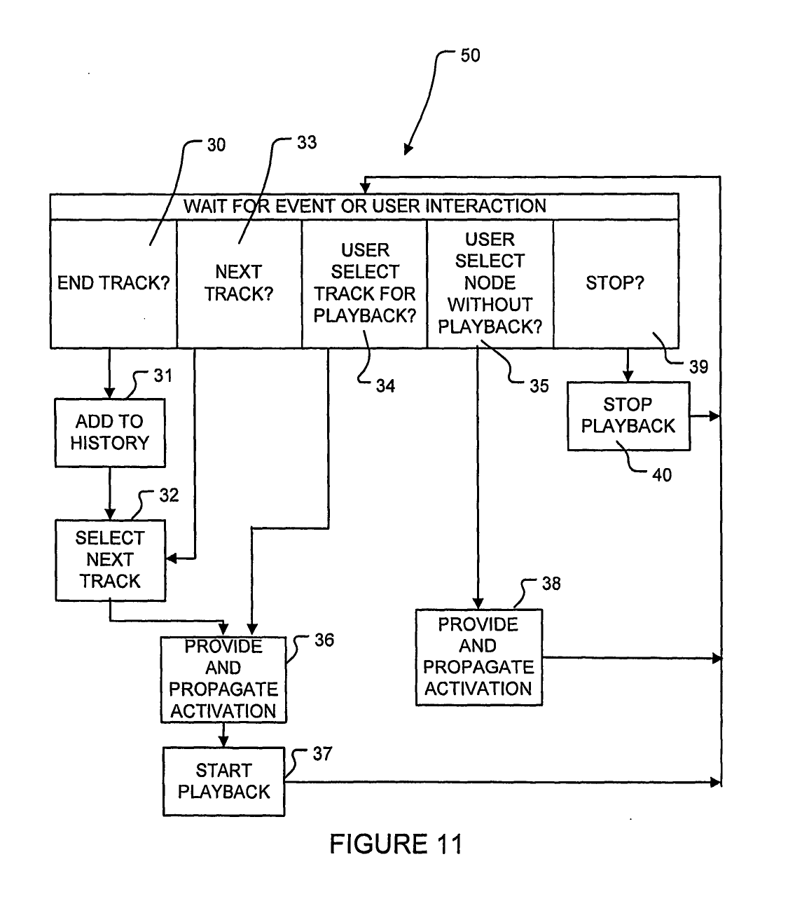

FIG. 11 depicts a state diagram which schematically depicts the playback functionality of a music playback system 12 according to a particular embodiment of the invention. Music playback system 12 maintains digital audio information in a network of the type described above. In the FIG. 11 embodiment, when playback of a musical track has finished (block 30), the track is added to the history list (block 31). The history list may be displayed on a user interface 15 similar to history list 406 shown in FIG. 10. In block 32, a next track may be automatically selected (by system 12 and/or software 16) or manually selected (by a user) for playback. The next track selected in block 32 may already be present in a playback queue 408 or may be added to playback queue 408 as a part of block 32.

The block 32 selection of a next track may involve any technique for manually or automatically selecting a node (representing a track) to be added to playback queue 408. The block 32 selection of a next track may involve automatic or manual selection of a node from among all of the media content nodes in network 10. The block 32 selection of a next track may involve automatic or manual selection of a node from among the nodes in a connected-node list, the nodes in a high-node-strength list, the nodes associated with a high-link-strength list and/or the nodes associated with a keyword list of the type described above. Automatic selection of nodes in block 32 may be sequential or may involve a pseudo-random process. Pseudo-random processes are well known to those skilled in the art.

In some embodiments, the block 32 selection of a next track may be automatically selected from a list, such as a high-node-strength list, for example. Automatic selection may be performed by a pseudo-random process wherein the probability of selection of a particular node from among the nodes in the high-node-strength list is correlated with the node strength of the particular node. Similar node selection processes may be performed with other lists, such as connected-node lists, high-link-strength lists and keyword lists. Criteria other than node strength may be selected to determine the probabilities. Such criteria may include keyword matching levels and link strengths for example.

Automatic selection of a next track from among the nodes in a connected-node list may involve computing a function of the node strengths of the nodes on the connected-node list and the link strengths of the links to such connected nodes and selecting the track represented by the node having the highest function output or assigning a probability of pseudo-random selection that is proportional to the function output. An example of such a function is fᵢ(αᵢ,assocᵢ)=a·αᵢ+b·assoc, where αᵢ is the node strength of the i^{th} node on the connected-node list and assocᵢ is the link strength of the link connecting the current node to the i^{th} node on the connected-node list and a and b are weighting coefficients for the node strength and the link strength respectively.

The block 32 selection of a next track may additionally or alternatively involve automatic or manual selection of a node from among the nodes contained in a playlist, which may be a user-defined playlist, a predefined playlist (such as an album) or an automatically created playlist.

Where the block 32 selection of a next track is automatic, the selection procedure may involve using a loop-prevention mechanism, such as a tabu list. A tabu list may comprise a list of recently played back tracks that are suppressed or are otherwise inhibited from being automatically selected in block 32. For example, when a track has finished playing, it may be time stamped and put on the tabu list. The tracks on the tabu list may stay on the tabu list for a predetermined or user-selectable period of time or for a predetermined or user-selectable number of discrete intervals t (e.g. a number of played back tracks).

In some embodiments, the block 32 selection of a next track and/or the incorporation of a tabu list may be performed in a manner similar to that described in the PCT patent application entitled, PROBABILSTIC AUDIO NETWORKS, which is filed concurrently with this application and which is hereby incorporated by reference herein.

In the FIG. 11 embodiment, the block 32 selection of a track to be added to playback queue 408 causes direct activation to be provided to the corresponding node in block 36 and corresponding propagation of this activation through network 10 via links as discussed above. Block 36 may also involve updating the node strengths and link strengths of network 10 as described above. Playback of the next track commences in block 37.

A user may activate a “next” input (block 33) prior to the completion of playback of the current track. In such a circumstance, music playback system 12 bypasses block 31 (i.e. adding the current track to the history list) and proceeds directly to block 32, where it selects a next track as discussed above. After selecting the next track in block 32, music playback system 12 proceeds to block 36, where the node associated with the next track may receive activation, such activation may be propagated to other nodes through links and the node strengths and link strengths of network 10 may be updated as discussed above. Playback of the next track commences in block 37.

A user may select the track represented by a particular node for playback (block 34). In such a circumstance, media playback system 12 proceeds to block 36, where the node representing the selected track may receive activation, such activation may be propagated to other nodes through links and the node strengths and link strengths of network 10 may be updated as discussed above. Playback of the next track commences in block 37.

As discussed above, a user may also select a node to be the currently-selected node (block 35) without adding the corresponding track to playback queue 408. In such a circumstance, media playback system 12 proceeds to block 38, where the currently-selected node receives activation. As a part of block 38, such activation is propagated to other nodes through links and the node strengths and link strengths of network 10 are updated as discussed above. When a user selects a node to be the currently-selected node without playback (block 35), block 37 is bypassed and no playback occurs.

A user may activate a “stop” input (block 39). In such a circumstance, audio device 12 stops playback of the current track (block 40) and returns to wait for the next event or user interaction.

As discussed above, when a particular node is selected as the currently-selected node in block 35, the currently-selected node may receive activation and such activation may be propagated through links to other nodes as described above. Media playback system 12 may be configured such that the node strengths and the link strengths of the network maintained by system 12 may be updated as a part of block 38 (even although the currently-selected node (block 35) is not yet being played back). Accordingly, the block 35 selection of a node as the currently-selected node together with the activation propagated in block 38 can be used for determining a track or tracks to be played back after the currently-playing track without disrupting playback of the currently-playing track. For example, an artist node may be selected as the currently-selected node in block 35 and the corresponding activation may be propagated through the network, tracks by the selected artist may move towards the top of a high-link-strength list and, as a result, may be displayed for easy selection by user or may be automatically selected with higher probability for subsequent playback in block 32.

The media playback system 12 described above may be used for storing, maintaining and providing access to media collections in various types of media playback systems. Preferably such media playback systems incorporate solid state memory, magnetic memory or optically recorded memory, or provide access to external data storage or networks which comprise media databases or other forms of accessible media. Non-limiting examples of systems which may be configured as media playback systems in accordance with the invention include:
portable media playback devices, cell phones or PDAs;
in-car audio systems;
in-home entertainment systems;
commercial entertainment systems (such as can be found in restaurants, shopping malls, etc.);
desktop or portable computer systems;
electronic media stores or databases which are accessed online; and
browsing and search stations in traditional media/music stores.
   The media playback system may be implemented as part of the firmware on a hardware device, as additional software which can be loaded and executed on a hardware device, and/or as a combination of hardware and software.

Another specific example is now provided to illustrate other features of the invention within the context of a particular embodiment. This exemplary application is merely intended to be an example of a possible application of the invention and as an explanatory aid to assist with describing the invention and is specifically not intended to limit the scope of the invention. System 12 may be a typical PC system, where it is desired to manage various types of information items 17, such as documents, emails, favorite URLs or the like.

For a PC system 12, one type of property node is a person node. A data structure (not shown) corresponding to a person node may comprise: a node identifier; a person name; a node strength; keywords descriptive of the person and/or characteristics of the person; a last update time stamp; a list of contact information for the person; a time/date stamp of last contact with the person; and an optional vector containing pointers to other nodes to which the person is connected (e.g. documents that the person might have co-authored, emails that the person may have sent and/or received and the like). In some embodiments, a person node may actually be a content node, where the information item 17 represented by the person node is the person's contact information.

One type of content node for a PC system 12 is a document node. A data structure (not shown) corresponding to a document node may comprise: a node identifier; a document name; a node strength; keywords descriptive of the document and/or characteristics of the document; a last update time stamp; a pointer to the document; a time/date of document creation; a date/time of last saved update to the document; and an optional list of pointers to person node(s) representing contributing author(s) for the document (person nodes are explained in more detail below).

Another type of content node in the case where system 12 is a PC system may be an email node. A data structure (not shown) corresponding to an email node may comprise: a node identifier; an email name (e.g. a subject line); a node strength; keywords descriptive of the email or characteristics of the email (e.g. addressee names, keywords contained in the body of the email or the subject of the email or other descriptive keywords); a last update time stamp; a pointer to the email; a time/date that the email was sent; a time/date that the email was received; a pointer to the person node representing the sender; pointer(s) to the person node(s) corresponding to the recipient(s); and a flag indicating whether the email was sent by system 12 or received by system 12.

Another type of content node that may be used for a PC system 12 is a favorite URL node. A data structure (not shown) corresponding to a favorite URL data may comprise: a node identifier; an URL name; a node strength; keywords descriptive of the URL or characteristics of the URL; a last update time stamp; a pointer to the URL; a time/date that the website corresponding to the URL was last accessed; a time/date that the URL was recorded as a favorite; and a pointer to the person node representing the person who recorded the URL as a favorite.

Where system 12 is a PC system, selecting a node to be the currently-selected node may involve accessing the information item 17 corresponding to the node, although this is not strictly necessary. An information item 17 in a PC system 12 may be accessed when its corresponding file is opened. As with the embodiments described above, accessing the information item 17 represented by a node may also cause the node to receive direct activation.

Non-limiting examples of links w_{AB}, w_{AC}, . . . in a PC system 12 include: a link for connecting a pair of e-mail nodes representing email messages sent by the same person; a link for connecting a document node to a person node which represents the author of the document; a link for connecting an email node to a favorite URL node where the email and the URL represented by the nodes share important keywords. Those skilled in the art will appreciate that there are many other links which can be envisaged for PC systems on the basis of the similarity of the properties of the information represented by their corresponding nodes.

Links w_{AB}, w_{AC}, . . . of network 10 may be created manually and/or automatically. Automatic link creation may be based on similarity of the information items 17 represented by nodes and/or the properties of these information items 17. For the case where system 12 is a PC system, non-limiting examples of automatically creating links (such as link w_{AD} of FIG. 2) between two nodes (such as nodes A and D) based on similar properties of the information items 17 represented by the nodes include: cases where the information items represented by node A shares common keywords with the information represented by node D (e.g. a node A email shares common keywords with a node D URL); and cases where the information represented by nodes A and D include explicit cross-references to one another or to a common node (e.g. a person represented by a person node A and is the author of a document represented by a document node D). Software for automatically extracting and analyzing the relevance of keywords and/or metadata from electronic documents, email files, URL's and the like is well known to those skilled in the art. Such keywords and metadata can also be manually extracted and analyzed.

Links (such as link w_{AD} of FIG. 2) between two nodes (such as nodes A and D) may also be created based on usage. For the case where system 12 is a PC system, a link w_{AD} may be created based on usage if the information items 17 represented by nodes A and D have both been accessed within a certain threshold interval or if the information item 17 represented by node D is repeatedly accessed immediately after the information item 17 represented by node A, for example.

The propagation of activation through a network 10 maintained by a PC system 12 and the display of one or more lists (e.g. a high-node-strength list) on the user interface 15 of a PC system 12 may be used in a manner similar to those of the systems described above to achieve similar advantages. For example, a PC system may display a high-node-strength list on a toolbar or the like, so that when a user is working on a particular document (activation is provided to the node corresponding to that document and propagated through network 10), such that the toolbar displays indicia from nodes that are related to the node corresponding to the particular document. The user may then access the information items corresponding to these related nodes without searching through their directory structures or email folders or the like.

Certain implementations of the invention comprise computer processors which execute software instructions which cause the processors to perform a method of the invention. For example, one or more processors in a dual modulation display system may implement data processing steps in the methods described herein by executing software instructions retrieved from a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. The instructions may be present on the program product in encrypted and/or compressed formats.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
Networks 10 described herein are merely example networks and, for ease of explanation, these example networks are shown with a relatively small number of nodes and links. Those skilled in the art will appreciate that networks according to the invention may generally have any number of nodes and/or links.
In the embodiments described above, network 10 comprises property nodes which do not directly represent a particular information item 17. Property nodes are optional. Network 10 and many of its advantageous characteristics can be implemented using content nodes without incorporating property nodes.
In some embodiments, network 10 may be resident on a server and users may access network 10 using systems or devices that are connected to the server via a communication network, such as a LAN or the internet, for example.
When node A is selected to be the current node, activation a: may be provided to node A. In the example, where system 12 is a media playback system and node A is a media content node, selecting node A to be the currently-selected node may involve playback of node A. The activation a provided to node A may be provided as soon as playback of the media content represented by node A is started or as soon as playback of the media content represented by node A is stopped. In one particular embodiment, activation is provided to node A when the media content represented by node A is stopped and the amount of activation α depends on the time that the media content was playing and the length of the media content according to a function:

α=f(m,d),

where: m=playback time (i.e. time playback stops—time playback starts); d is the length of the media content; and f(m, d): [symbol] ⁺× [symbol] ⁺→ [symbol] . In one particular example f(m, d) may be given by f(m, d):=e_{y}·exp[−(d−m)²], where the parameter eₜ determines the maximum amount of activation that will be received when the track has been played completely (d=m)
In the embodiments described above, direct activation may be provided to a node by accessing the information item 17 corresponding to the node or to selecting the node to be the “currently-selected” node. In some embodiments, neither of these techniques are necessary and a user may take some action or enter some instruction which causes system 12 and/or software 16 to provide direct activation to a particular node or group of nodes.
   Accordingly, the scope of the invention is to be construed in accordance with the substance defined by the following claims.

1. A method for organizing a plurality of accessible information items:
providing a plurality of nodes, each node corresponding to one of the information items and each node having an associated node strength;
providing a plurality of links, each link representing a connection between a corresponding pair of nodes;
selecting a first node from among the plurality of nodes to be a currently-selected node;
in response to selection of the first node as the currently-selected node, increasing the node strength of the first node.

2. A method according to claim 1 comprising maintaining a high-node-strength list, the high-node-strength list comprising a list of some of the nodes from among the plurality of nodes that is ordered by node strength.

3. (canceled)

4. A method according to claim 2 comprising displaying, on a user interface, indicia identifying the information items corresponding to the nodes on the high-node-strength list.

5. A method according to claim 4 comprising allowing a user to access a desired information item corresponding to a particular node on the high-node-strength list by selecting the displayed indicia corresponding to the desired information item and providing an indication that access is requested.

6. A method according to claim 1 comprising:
in response to selection of the first node as the currently-selected node, propagating activation from the first node to one or more second nodes from among the plurality of nodes over one or more first links from among the plurality of links, each first link connecting the first node to a corresponding one of the second nodes;
receiving the activation at the one or more second nodes; and
in response to receiving the activation at the one or more second nodes, increasing the node strengths of the one or more second nodes.

7. A method according to claim 6 comprising providing each of the plurality of links with a corresponding link strength, wherein an amount of activation propagated from the first node to each of the one or more second nodes depends on the link strength of the first link connecting the second node to the first node.

8. A method according to claim 6 comprising providing each of the plurality of links with a corresponding link strength, wherein for each of the one or more second nodes, an amount of increase in the node strength of the second node in response to receiving the activation depends on the link strength of the first link connecting the second node to the first node.

9. A method according to claim 6 comprising:
providing each of the plurality of links with a corresponding link strength; and
in response to propagating the activation from the first node to the one or more second nodes over the one or more first links, increasing the link strengths of the one or more first links.

10. (canceled)

11. A method according to claim 1 comprising, in response to selection of the first node as the currently-selected node, increasing the node strengths of one or more second nodes, each of the one or more second nodes connected to the first node by a corresponding first link.

12. A method according to claim 11 comprising providing each of the plurality of links with a corresponding link strength, wherein for each of the one or more second nodes, an amount of increase in the node strength of the second node depends on the link strength of the first link connecting the second node to the first node.

13. A method according to claim 11 comprising:
providing each of the plurality of links with a corresponding link strength; and
in addition to increasing the node strength of the one or more second nodes, increasing the links strengths of the one or more corresponding first links.

14. A method according to claim 5 comprising:
in response to selection of the first node as the currently-selected node, propagating activation from the first node to one or more second nodes from among the plurality of nodes over one or more first links from among the plurality of links, each first link connecting the first node to a corresponding one of the second nodes;
receiving the activation at the one or more second nodes; and
in response to receiving the activation at the one or more second nodes, increasing the node strengths of the one or more second nodes.

15. (canceled)

16. (canceled)

17. (canceled)

18. (canceled)

19. A method according to claim 6 wherein increasing the node strength of the first node and increasing the node strengths of the one or more second nodes occurs at the conclusion of a discrete interval in which the first node is selected as the currently selected node.

20. A method according to claim 9 wherein increasing the link strengths of the one or more first links occurs at the conclusion of a discrete interval in which the first node is selected as the currently selected node.

21. A method according to claim 6 comprising causing the node strengths of each of the plurality of nodes to decay in response to passage of a discrete interval.

22. A method according to claim 20 comprising causing the link strengths of each of the plurality of links to decay in response to the passage of the discrete interval.

23. A method according to claim 21 wherein causing the node strengths of each of the plurality of nodes to decay comprises ensuring that the node strengths of each of the plurality of nodes do not decay to below a corresponding baseline node strength level.

24. A method according to claim 22 wherein causing the links strengths of each of the plurality of links to decay comprises ensuring that the links strengths of each of the plurality of links do not decay to below a corresponding baseline link strength level.

25. A method according to claim 14 wherein increasing the node strength of the first node and increasing the node strengths of the one or more second nodes occurs at the conclusion of a discrete interval in which the first node is selected as the currently selected node and wherein the method comprises, after increasing the node strength of the first node and increasing the node strengths of the one or more second nodes, resorting the high-node-strength list and the corresponding displayed indicia.

26. A method according to claim 14 wherein selecting the first node to be the currently-selected node comprises selecting the indicia identifying the information item corresponding to the first node and providing an indication that the first node should be the currently-selected node.

27. A method according to claim 14 wherein each of the plurality of nodes comprises a data structure containing a keyword field comprising one or more keywords descriptive of the information item corresponding to the node.

28. A method according to claim 27 comprising: receiving a keyword input from a user; identifying, from among the plurality of nodes, one or more keyword-matching nodes having the keyword input in their corresponding keyword fields; and increasing the node strengths of the one or more keyword-matching nodes.

29. (canceled)

30. A method according to claim 28 comprising, for each of the one or more keyword matching nodes:
propagating activation from the keyword-matching node to one or more second keyword-matching nodes from among the plurality of nodes over one or more first keyword-matching links from among the plurality of links, each first keyword-matching link connecting the keyword-matching node to a corresponding one of the second keyword-matching nodes;
receiving the activation at the one or more second keyword-matching nodes; and
in response to receiving the activation at the one or more second keyword-matching nodes, increasing the node strengths of the one or more second keyword-matching nodes.

31. A method according to claim 30 wherein, for each keyword-matching node, an amount of activation propagated from the keyword-matching node to each of the one or more second keyword-matching nodes depends on the link strength of the first keyword-matching link connecting the second keyword-matching node to the keyword-matching node.

32. A method according to claim 30 wherein, for each keyword-matching node, an amount of increase in the node strengths of the one or more second keyword-matching nodes depends on the link strength of the first keyword-matching link connecting the second keyword-matching node to the keyword-matching node.

33. A method according to claim 30 comprising, for each keyword-matching node, in response to propagating the activation from the keyword-matching node to the one or more second keyword-matching nodes over the one or more first keyword-matching links, increasing the link strengths of the one or more first keyword matching links.

34. (canceled)

35. A method according to claim 30 comprising, for each of the one or more keyword-matching nodes:
propagating secondary activation from the keyword-matching node to one or more third nodes from among the plurality of nodes over one or more second links from among the plurality of links;
receiving the secondary activation at the one or more third nodes; and
in response to receiving the secondary activation at the one or more third nodes, increasing the node strengths of the one or more third nodes.

36. (canceled)

37. A method according to claim 28 comprising identifying, from among the plurality of nodes, one or more keyword-similar nodes having one or more keywords similar to the keyword input to within a similarity threshold; and increasing the node strengths of the one or more keyword-similar nodes.

38. A method according to claim 37 wherein the increase in the node strengths of the one or more keyword-similar nodes is less than the increase in the node-strengths of the one or more keyword-matching nodes.

39. A method according to claim 27 comprising: receiving a keyword input from a user; ranking the plurality of nodes in accordance with a degree of similarity between the keyword input and the one or more keywords in their corresponding keyword fields; and displaying, on the user interface, indicia identifying the information items corresponding to the nodes on the high node strength list only if the degree of similarity between the keyword input and the one or more keywords in the keyword fields of the nodes on the high-node-strength list are greater than a keyword similarity threshold.

40. A method according to claim 14 comprising:
providing a property node having an associated node strength;
providing one or more property links representing one or more connections between the property node and one or more common-property nodes from among the plurality of nodes, wherein the one or more common-property nodes correspond to one or more information items that exhibit a common property.

41. (canceled)

42. A method according to claim 40 comprising:
selecting the property node to be a currently-selected property node;
in response to selection of the property node as the currently-selected property node, propagating activation from the property node to the one or more common-property nodes over the one or more property links;
receiving the activation at the one or more common-property nodes; and
in response to receiving the activation at the one or more common-property nodes, increasing the node strengths of the one or more common-property nodes.

43. A method according to claim 42 comprising providing each of the one or more property links with a corresponding link strength, wherein an amount of activation propagated from the property node to each of the one or more common-property nodes depends on the link strength of the property link connecting the common-property node to the property node.

44. A method according to claim 42 comprising providing each of the one or more property links with a corresponding link strength, wherein for each of the one or more common-property nodes, an amount of increase in the node strength of the common-property node in response to receiving the activation depends on the link strength of the property link connecting the common-property node to the property node.

45. A method according to claim 42 comprising:
providing each of the one or more property links with a corresponding link strength; and
in response to propagating the activation from the property node to the one or more common-property nodes over the one or more property links, increasing the link strengths of the one or more property links.

46. (canceled)

47. A method according to claim 42 comprising, for each of the one or more common-property nodes:
propagating secondary activation from the common-property node to one or more third nodes from among the plurality of nodes over one or more second links from among the plurality of links;
receiving the secondary activation at the one or more third nodes; and
in response to receiving the secondary activation at the one or more third nodes, increasing the node strengths of the one or more third nodes.

48. (canceled)

49. A method according to claim 42 wherein the information items comprise media tracks and the common property comprises one or more of: an artist involved in the creation of the media tracks; an album on which the media tracks were released; a user-defined playlist containing the media tracks; a genre into which the media tracks are classified; spectral properties of the media tracks; and tempo of the media tracks.

50. A method according to claim 42 wherein the information items comprise electronic documents and the common property comprises one or more of: an author involved in the creation of the documents; one or more keywords in the documents; one or more keywords in a filename of the documents; a date on which the documents were created; and a date on which the documents were last accessed.

51. A method according to claim 6 comprising, for each of the one or more second nodes:
propagating secondary activation from the second node to one or more third nodes from among the plurality of nodes over one or more second links from among the plurality of links;
receiving the secondary activation at the one or more third nodes; and
in response to receiving the secondary activation at the one or more third nodes, increasing the node strengths of the one or more third nodes.

52. (canceled)

53. A method according to claim 1 comprising:
in response to selection of the first node as the currently-selected node, propagating activation from the first node to one or more second nodes from among the plurality of nodes;
receiving the activation at the one or more second nodes;
in response to receiving the activation at the one or more second nodes, increasing the node strengths of the one or more second nodes; and
selecting one of the plurality of nodes to be a next selected node.

54. A method according to claim 53 wherein selecting one of the plurality of nodes to be a the next selected node causes creation of a link between the first node and the next selected node.

55. A method according to claim 53 wherein selecting one of the plurality of nodes to be the next selected node causes an increase in the link strength of a link between the first node and the next selected node.

56. A method according to claim 6 wherein the information items comprise media content.

57. A method according to claim 6 wherein the information items comprise electronic documents.

58. A method according to claim 6 wherein the information items comprise at least two information items of different types.

59. A system for organizing information items comprising:
data storage for storing a plurality of information items;
a node creation engine for creating a plurality of nodes, each node representing a corresponding one of the information items and each node having a corresponding node strength;
a link creation engine for creating a plurality of links, each link representing a connection between a corresponding pair of nodes;
an activation propagation manager for receiving, from a user interface, an indication of a currently-selected node, and in response to the indication:
increasing the node strength of the currently-selected node;
propagating activation from the currently-selected node to one or more second nodes over one or more first links from among the plurality of links, each first link connecting the currently-selected node to a corresponding one of the second nodes; and
in response to receiving the activation at the one or more second nodes, increasing the node strengths of the one or more second nodes; and
a node strength tracker for monitoring and maintaining the node strengths of the plurality of nodes.

60. A system according to claim 59 comprising a high-node-strength list generator for maintaining a high-node-strength list comprising a list of some of the nodes from among the plurality of nodes that is ordered by node strength.

61. A system according to claim 60 wherein the high-node-strength list generator displays, on a user interface, indicia identifying the information items corresponding to the nodes on the high-node-strength list.

62. A system according to claim 61 where the user interface allows a user to access a desired information item corresponding to a particular node on the high-node-strength list by selecting the displayed indicia corresponding to the desired information item and providing an indication that access is requested.
